(19) United States
(12) Patent Application Publication
(10) Pub. No.: US 2002/0056388 A1
(43) Pub. Date: May 16, 2002

(54) Lithographic printing plate precursor, printing method and printing machine

(76) Inventors: Naonori Makino, Shizuoka (JP); Yutaka Sakasai, Shizuoka (JP); Tetuo Usui, Shizuoka (JP); Seishi Kasai, Shizuoka (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/955,997

(22) Filed: Sep. 20, 2001

(30) Foreign Application Priority Data
Sep. 28, 2000 (JP) P.2000-297369
Oct. 18, 2000 (JP) P.2000-318056
Dec. 27, 2000 (JP) P.2000-398054
Dec. 27, 2000 (JP) P.2000-398057

(51) Int. Cl. B41N 1/00; B41N 3/00

(52) U.S. Cl. 101/453

(57) ABSTRACT

A lithographic printing plate precursor comprising an image-forming layer provided on a support by applying an electric field between the support and a dispersion containing an electric charged particulate high molecular polymer to cause electrodeposition of the particulate high molecular polymer on the support;

a printing method comprising a step of forming a particulate layer on a water-receptive support mounted on a printing machine's plate cylinder by applying an electric field between the support and an electric charged particulate high molecular polymer to cause electrodeposition of the particulate high molecular polymer on the support, a step of subjecting the particulate layer to imagewise exposure, a step of removing non-image areas by applying ink or water thereto or by giving them a rub to make a printing plate, and a step of subjecting the printing plate to a printing work; and

a printing machine comprising a plate cylinder on which a water-receptive support is mounted, a device for forming a particulate layer on the water-receptive support by applying an electric field between the support and an electric charged particulate high molecular polymer to cause electrodeposition of the particulate high molecular polymer on the support, and an image drawing unit equipped with an exposure light source; are disclosed.

### FIELD OF THE INVENTION

The present invention relates to a lithographic printing plate precursor, a printing method and a printing machine (i.e., a printing press). More specifically, the present invention relates to a lithographic printing plate precursor that enables plate-making by scanning exposure based on digitized signal images, can ensure a high speed and a long press life in lithographic printing and provide stain-free printed matter, and further can be mounted in a printing machine without undergoing development-processing. In addition, the present invention relates to a printing method wherein both formation of a printing plate precursor and plate-making from the printing plate precursor are carried out on a printing machine for performing printing operations, and beside, plate-making and a chain of printing operations on a level of meeting requirements of a high speed, a long press life and high scumming (or staining) resistance can be repeated using the same printing plate precursor-mounted printing machine, and a printing machine for implementing the aforesaid printing method.

### BACKGROUND OF THE INVENTION

In general, a lithographic printing plate is comprised of oleophilic image areas capable of receiving ink during the printing process and hydrophilic non-image areas capable of receiving a fountain solution. Hitherto, such a lithographic printing plate has been made generally by subjecting a PS plate comprising a hydrophilic support provided with an oleophilic photopolymer layer to mask exposure via lith film, and then dissolving the non-image area in a developer and removing it.

In recent years, the digitization technique of electronically processing, accumulating and outputting image information has come into widespread use. As a result, there has demanded a longing for computer-to-plate (CTP) technique, wherein highly directional active radiation, such as laser beams, is scanned according to digitized image information and form images directly on a lithographic printing plate precursor.

In the conventional plate-making process using a PS plate, on the other hand, the step of removing non-image areas by dissolution after exposure is indispensable, and further it is generally necessary to carry out after-processing steps of washing the development-processed plate with water or/and a rinsing solution containing a surfactant and treating the plate with a desensitizing solution containing a starch derivative. The necessity for such additional wet processing steps is another problem which has been expected to be addressed in improving the conventional techniques. Lately in particular, consideration for global environment has become a great concern for all industries.

From viewpoints of environmental friendliness and rationalization of processing steps accompanied by the digitization as described above, it has come to be strongly desired that processing steps be made simple and dry, or the need therefor be eliminated.

In other words, the plate-making and graphic arts industries have pursued the rationalization of the plate-making process in recent years, and have desired to develop printing plate precursors having no need of complex image exposure via lith film and wet development-processing, and besides, capable of being used for printing without any further processing after CTP image recording.

As one method of simplifying the processing steps, there is the method referred to as “on-machine development” or “on-press development” wherein the exposed printing plate precursor is mounted on a cylinder and thereto a fountain solution and ink are fed while rotating the cylinder, thereby removing the non-image areas from the printing plate precursor. In other words, this method is a method of mounting a printing plate precursor in a printing machine directly after exposure and completing the processing within the course of usual printing.

Lithographic printing plate precursors suitable for such an “on-machine development” method are required to have not only photosensitive layers soluble in a fountain solution and an ink solvent but also a bright room handling suitability in view of development on a printing machine installed in a bright room.

JP-A-2000-141933 (the term “JP-A” as used herein means an “unexamined published Japanese patent application”) discloses a plate-making method wherein an image-forming material having on a support a layer containing fine particles of a high polymer dispersible in an aqueous or non aqueous solvent is subjected to imagewise exposure by means of an infrared semiconductor laser source to form images by heat fusion of the fine particles, and then the resulting material is mounted in a printing machine and subjected to printing operations with offset ink; as a result, it undergoes development at the initial stage of printing to be made into a printing plate.

JP-A-10-58851 discloses a lithographic printing member comprising a hydrophilic support provided with a water-based coating (heat-sensitive layer) comprising a hydrophilic binder, a compound capable of converting light into heat and hydrophobic thermoplastic polymer particles, and gives a description such that, after the member undergoes scanning exposure to infrared laser and the heat generated thereby causes coalescence of polymer particles to effect image formation, it is possible to develop the member on a printing machine with a fountain solution and/or ink.

Although such a method of forming images merely by heat fusion and coalescence of high polymer particles can provide satisfactory on-machine developability (i.e., on-press developability), the images formed are low in water resistance and image strength, so the method has a problem of being incapable of ensuring a sufficiently long press life.

With a recent trend in lithographic printing techniques, there have been proposed on lithographic printing of on-machine direct image-formation type making a printing plate directly on a printing machine with which printing operations are performed. For instance, formation of images for lithographic printing plate by providing on the surface of a plate cylinder usually used for offset printing a resin layer changing its solubility in an aqueous solution by light or heat, a layer containing heat-fusible particles or a layer causing ablation by light or heat, formation of lithographic printing plate images by providing an electrophotographic photoreceptor and utilizing electrophotographic process, and formation of lithographic printing plate images by an ink-jet recording method have been studied or put to practical use.

However, the formation of a resin layer changing its solubility in alkaline water by light or heat requires an organic solvent of the type which is comparatively expensive, deleterious to humans and inflammable. In addition, there arises a need for installing an apparatus for development-processing with alkaline water after recording images.

In providing a layer containing heat-fusible particles, on the other hand, such particles are generally coated in a state of being dispersed in an aqueous dispersing medium. Accordingly, there is a problem that an operation under a high temperature is required for evaporating the aqueous dispersing medium after coating and an apparatus therefor becomes necessary.

In the case of a layer causing ablation by light or heat, the formation of such a layer is attended with a problem of requiring an organic solvent which is comparatively expensive, detrimental to health and flammable.

In the case where toner images formed on a photoconductive photoreceptor by electrophotographic process are transferred onto a support to make a lithographic printing plate, relatively many processing steps, including electrification, exposure and development with toner, are required. Therefore, there is a problem of necessitating an increase in number of devices for such processing steps.

Likewise, the case of utilizing an ink-jet recording method for forming lithographic printing plate images on a hydrophilic support has a problem of necessitating an ink-jet nozzle and an apparatus for desensitizing non-image areas.

Furthermore, in JP-A-10-58851 are disclosed the production of a lithographic printing member which enables image formation and printing operations to be performed with one apparatus and the apparatus used therefor. And the lithographic printing member disclosed therein comprises a hydrophilic support provided with a water-based coating (heat-sensitive layer) containing hydrophobic thermoplastic polymer particles, and adopts a method of forming images by merely applying heat to hydrophobic thermoplastic polymer particles to cause fusion and coalescence therein. Therefore, satisfactory on-machine developability can be achieved, but there are problems that scumming resistance (i.e., staining resistance) is insufficient and a press life is short because water resistance and image strength are low.

### SUMMARY OF THE INVENTION

Therefore, an object of the present invention is to provide a lithographic printing plate precursor overcoming the aforesaid problems of prior arts, specifically a lithographic printing plate precursor having satisfactory on-machine developability and high sensitivity from which lithographic printing plates having long press life can be made consistently.

Another object of the present invention is to provide a lithographic printing plate precursor which enables image formation by short scanning exposure to laser beams and plate-making by simple development-processing with water or in a state of being directly mounted in a printing machine without undergoing development-processing.

Still another object of the present invention is to provide a lithographic printing plate precursor, a printing method and a printing machine which surmount the aforedescribed drawbacks of prior arts. Specifically, this object is to provide a lithographic printing plate precursor and a printing method and a printing machine (i.e., a printing press), which enable formation of a lithographic printing plate precursor and plate-making to be effected on a printing machine where printing operations are carried out and can ensure high speed, a long press life and excellent scumming resistance in repetitions of lithographic printing.

A further object of the present invention is to provide a printing method and a printing machine which enable not only formation of an image-forming layer without requiring organic solvents of the type which are comparatively expensive, deleterious to humans and flammable but also reduction in the number of processing steps for formation of lithographic printing plate images and the number of devices for these processing steps, and further can ensure a high speed and a long press life in lithographic printing.

A still further object of the present invention is to provide a lithographic printing plate precursor which overcomes the aforementioned drawbacks of the prior arts and thereby comes to have satisfactory on-machine developability and high sensitivity and enables consistent making of lithographic printing plates having long press life, and to a printing method by which organic solvents comparatively expensive, deleterious to humans and dangerous due to its high flammability can be rendered unnecessary for formation of an image-forming layer, the number of processing steps for formation of lithographic printing plate images and the number of devices for these processing steps can be reduced, and a high speed printing and a long press life can be ensured.

As a result of our intensive studies to attain the aforesaid objects, it has been found that the aforementioned drawbacks of prior arts can be overcome by adopting the constitutions as described below.

Specifically, embodiments of the present invention are as follows:

(1) A lithographic printing plate precursor comprising a support and an image-forming layer containing a particulate high molecular polymer, with the image-forming layer being provided on the support by applying an electric field between the support and a dispersion containing an electric charged particulate high molecular polymer to cause electrodeposition of the particulate high molecular polymer on the support.

(2) The lithographic printing plate precursor according to Embodiment (1), wherein the particulate high molecular polymer has heat-fusible properties.

(3) The lithographic printing plate precursor according to Embodiment (1), wherein the dispersion is a disperse system containing the electric charged particulate high molecular polymer in an electric insulating liquid as a dispersion medium.

(4) The lithographic printing plate precursor according to Embodiment (1), wherein the dispersion further contains a light-to-heat converting agent.

The lithographic printing plate precursor of the present invention is characterized by how an image-forming layer (heat-sensitive layer) is provided on a support. Specifically, the image-forming layer is formed by applying an electric field between the support and a dispersion of an electric charged particulate high molecular polymer to cause electrodeposition of the particulate high molecular polymer on the support. More specifically, toner particles of an electrophotographic liquid developer are electrodeposited by utilizing their electric charges, thereby forming an image-forming layer.

As a result, the image-forming layer is constituted mainly of uniform particles of high molecular polymer, and therein the fine particles are present in a semi-bonded state that there are voids among some particles though some particles are in contact with one another since the fine particles of a high molecular polymer are electrodeposited on the support, in contrast to being coated. Therefore, in the image formation by heat fusion of fine particles upon scanning exposure to laser beams in the infrared region, the fine particles of a high molecular polymer have satisfactory heat-fusible properties and can ensure high image strength. In the unexposed areas (non-image areas), on the other hand, the fine particles are removed in aggregates of moderate sizes. So the fine particles in the unexposed areas can have good removability, or good developability, and can be removed using a fountain solution or ink on a printing machine. Thus, it becomes possible to make a lithographic printing plate generating no scumming (i.e., no staining) in printing and having a long press life.

In other words, we have found that scumming-free and long press-life printing can be attained by using fine particles of an electric charged high molecular polymer, forming a layer of photosensitive particles (or an image-forming layer) on a printing machine, forming images by laser-beam scanning exposure, and subsequently removing non-image areas by applying a fountain solution or ink or giving a rub thereto, thereby also achieving the present invention.

(5) A printing method comprising a step of forming a particulate layer on a water-receptive support mounted on a printing machine's plate cylinder by applying an electric field between the support and fine particles of an electric charged high molecular polymer to cause electrodeposition of the fine particles of the high molecular polymer on the support, a step of subjecting the particulate layer to imagewise exposure, a step of removing non-image areas by applying ink or water thereto or by giving them a rub to make a printing plate, and a step of subjecting the printing plate to a printing work.

(6) The printing method according to Embodiment (5), further comprising a step of regenerating the water-receptive support after carrying out the printing work, wherein the printing plate surface is cleaned with chemical or physical treatment and thereby the image areas on the plate surface are removed.

(7) A printing machine comprising a plate cylinder on which a water-receptive support is mounted, a device for forming a particulate layer on the water-receptive support by applying an electric field between the support and fine particles of an electric charged high molecular polymer to cause electrodeposition of the fine particles on the support, and an image drawing unit equipped with an exposure light source.

More specifically, the printing method and a printing machine of the present invention therefore form a direct imaging system wherein an electrophotographic liquid developer (toner) is utilized as a dispersion of particulate high molecular polymer having electric charge, the particulate high molecular polymer is electrodeposited on a water-receptive support mounted on a plate cylinder installed in the printing machine and thereby a photosensitive particulate layer (image-forming layer) is formed, negative images are formed on the support by thermal fusion of the particles in areas exposed to laser beams, the particles in areas not exposed to laser beams are removed by the use of a fountain solution or printing ink on the printing machine, and the thus made printing plate is subjected to printing operations, and besides, after the printing operations are finished, the printing plate is regenerated by wiping the printing plate surface with a cleaner, electrodeposition thereon is repeated and then the printing operations are carried out again according to the aforementioned procedure.

The formation of a particulate layer (image-forming layer) on a water-receptive support mounted on a printing machine's plate cylinder is characterized in that an electric field is applied between a dispersion of particulate high molecular polymer having an electric charge and the support to electrodeposit the fine particles on the support.

The dispersion of particulate high molecular polymer contains an electric insulating liquid (non-aqueous solvent) as a dispersion medium. As the electric insulating liquid, isoparaffin petroleum solvents are mainly used. These solvents have higher boiling points than general organic solvents, and they are free of a drawback of catching fire from static electricity, so they are safe from causing a disaster. In addition, as they have boiling points lower than aqueous dispersion media, they are favorable for air drying in the step of forming the particulate layer (image-forming layer).

Further, in forming an image-forming layer, there is no need for the printing method and printing machine of the present invention to use a generally required organic solvent which is comparatively expensive, deleterious to humans and flammable. And the printing method of the present invention makes it possible to reduce the number of processing steps for formation of lithographic printing plate images and the number of devices for these processing steps as well.

The other feature of the printing method and printing machine of the present invention consists in that, after the printing has been done via general printing steps, it is possible to clean the plate surface by chemical and/or physical treatment and remove the images therefrom, thereby effecting regeneration of the water-receptive support.

In the printing machine of the present invention, a plate surface-cleaning unit is installed in the vicinity to a plate cylinder. In the interim between one printing work and the next printing work, this cleaning unit makes it feasible to wipe out the ink or fountain solution adhering to the surface of printing plate material (water-receptive support) at the conclusion of printing work, and subsequently to remove the toner image areas brought in close contact with and fixed to the plate surface by chemical and/or physical treatment as described hereinafter.

The image-forming layer is constituted mainly of uniform fine particles of a high molecular polymer. As these fine particles are attached to a support by electrodeposition, they are present in a semi-bonded state that there are voids among some particles though some particles are in contact with one another, as compared with the case where they are coated. Therefore, in the image formation by heat fusion of fine particles upon scanning exposure to laser beams in the infrared region, the fine particles of a high molecular polymer have satisfactory heat-fusible properties and can ensure high image strength. In the unexposed areas (non-image areas), on the other hand, the fine particles are removed in aggregates of moderate sizes. So the fine particles in the unexposed areas can have good removability, or good developability, and can be removed using a fountain solution or ink on a printing machine. Thus, it becomes possible to make a lithographic printing plate generating no scumming and having a long press life.

According to the printing method and printing machine of the present invention, both formation of an image-forming layer by electrodeposition and imagewise exposure are performed on the printing machine, so that the present invention can embody the so-called Computer-to-Cylinder (CTC) printing system capable of eliminating a plate-making step. Thus, much time and cost required for usual PS plate production become unnecessary, so printings are obtainable at low prices and on short lead times. Moreover, the plate replacement after conclusion of each printing work becomes unnecessary, so that there is no need to dispose of waste plates, and savings in time, labor and cost become possible.

In addition to the aforementioned embodiments, it has been found that when a photosensitive particulate layer (image-forming layer) is formed by electrodepositing fine particles of a high molecular polymer having an electric charge on a water-receptive support containing anatase-type titanium dioxide and being mounted on a printing machine, and subsequently images are formed therein by laser beam scanning exposure, the non-image areas can be removed with a fountain solution or ink or by giving a rub thereto and a printing plate capable of generating no scumming (i.e., no staining) and having a long press life can be made, and besides, even when the formation of a lithographic printing plate precursor and the plate-making from the printing plate precursor are repeated on the printing machine, no scumming and a long press life can be ensured in each printing plate, thereby attaining the following embodiments:

(8) A lithographic printing plate precursor comprising a water-receptive support having a water-receptive layer containing anatase-type particulate titanium dioxide, and an image-forming layer provided on the support by applying an electric field between the support and a dispersion containing an electric charged particulate high molecular polymer to cause electrodeposition of the particulate high molecular polymer on the support.

(9) A printing method which comprises forming an image-forming layer by applying an electric field between a water-receptive support provided with a water-receptive layer containing anatase-type particulate titanium dioxide and mounted on a printing machine's plate cylinder and a dispersion containing fine particles of an electric charged high molecular polymer in an electric insulating liquid to electrodeposit the fine particles of the high molecular polymer on the support, subjecting the image-forming layer to imagewise exposure; removing non-image areas by applying ink or water thereto or giving them a rub to make a printing plate; and carrying out a printing work after removal of the non-image areas.

(10) The printing method according to Embodiment (9), further comprising a step of regenerating the water-receptive support after carrying out the printing work, wherein the printing plate surface is cleaned with chemical or physical treatment to remove image areas therefrom and then irradiated with ultraviolet rays.

(11) A printing machine comprising a plate cylinder on which a water-receptive support having a water-receptive layer containing anatase-type particulate titanium dioxide is mounted, a device for forming a particulate layer on the water-receptive support by applying an electric field between the support and fine particles of an electric charged high molecular polymer to cause electrodeposition of the fine particles on the support, an image drawing unit equipped with an exposure light source, a plate surface-cleaning unit and an ultraviolet irradiation device.

The lithographic printing plate precursor, printing method and printing machine of the present invention constitute a direct imaging system. Specifically, the present invention comprises a printing method wherein an electrophotographic liquid developer (toner) is used as a dispersion of fine particles of an electric charged high molecular polymer, formation of a photosensitive particulate layer (image-forming layer) is carried out on a printing machine by electrodepositing the fine particles on a water-receptive support mounted on the printing machine's plate cylinder, negative images are formed on the support through heat fusion of the particles by imagewise exposure to laser beams, removal of unexposed areas from the support surface is carried out on the printing machine by the use of a fountain solution or ink, and then printing is done, or a printing method wherein after a printing work is done according to the aforementioned printing method the printing plate is regenerated by a wiping with a plate surface cleaner, a repeat of the electrodeposition and subsequent operations described above and then subjected to a printing work again, and printing machines for practicing the foregoing methods.

One feature of the lithographic printing plate precursor of the present invention consists in that the particulate layer (image-forming layer) on the water-receptive support mounted on the printing machine's plate cylinder is a layer formed by applying an electric field between the water-receptive support and a dispersion of fine particles of an electric charged high molecular polymer to cause electrodeposition of the fine particles on the support.

Furthermore, it has been found that the above-described drawbacks of prior arts can be overcome by the following, thereby achieving the present invention:

(12) A lithographic printing plate precursor having on a support an image-forming layer comprising thermoplastic polymer particles having multiple whisker-shaped projections and a light-to-heat converting agent. (13) The lithographic printing plate precursor having the foregoing constitution (12), wherein the image-forming layer is provided on the support by applying an electric field between the support and a dispersion containing at least thermoplastic polymer particles having multiple whisker-shaped projections, a light-to-heat converting agent and an electric charge modifier in an electric insulating liquid to cause electrodeposition of the thermoplastic polymer particles on the support.

(14) A printing method comprising a step of forming an image-forming layer by applying an electric field between a water-receptive support mounted on a printing machine's plate cylinder and a dispersion containing at least thermoplastic polymer particles having multiple whisker-shaped projections, a light-to-heat converting agent and an electric charge modifier in an electric insulating liquid to cause electrodeposition of the thermoplastic polymer particles on the support, a step of subjecting the image-forming layer to imagewise exposure, and a step of carrying out printing after removal of non-image areas by applying ink or water or giving a rub.

The lithographic printing plate precursor of the present invention can produce the following effects by incorporating in the image-forming layer thermoplastic polymer particles having multiple whisker-shaped projections:

(1) When the image-forming layer is formed, thermoplastic polymer particles are in a state of tangled masses; as a result, the particles in non-image areas are not removed independently of each other, but they can be removed in masses.

(2) When the image-forming layer is formed, thermoplastic polymer particles are in a state of tangled masses; as a result, heat conduction in image areas exposed becomes effective and sufficient heat fusion can occur.

(3) In forming the image-forming layer, the particulate thermoplastic polymer-containing dispersion used is stable, and the particulate thermoplastic polymer can be redispersed with ease.

When the thermoplastic polymer particles have no whisker-shaped projections, the non-image areas cannot be removed to a sufficient extent, so when printing machines or printing conditions vary among cases, on-machine development of non-image areas became insufficient in some of the cases. In the case of insufficient on-machine development, idle running required for a printing machine to commence printing cannot be made consistent, so the printings obtained bear a scumming problem.

On the other hand, the lithographic printing plate precursor of the present invention enables reduction in idle running time required for on-machine development and improvement in scumming problem of printings.

The lithographic printing plate precursor of the present invention can be produced by providing on a support an image-forming layer in a manner that an electric filed is applied between the support and a dispersion containing at least thermoplastic polymer particles having multiple whisker-shaped projections, a light-to-heat converting agent and an electric charge modifier in an electric insulating liquid and thereby the thermoplastic polymer particles are electrodeposited on the support.

More specifically, the image-forming layer can be formed by using an electrophotographic liquid developer containing toner particles having whisker-shaped projections and applying an electric field to the developer to cause electrodeposition through the use of electric charges of these toner particles.

As a result, the image-forming layer is made up of uniform thermoplastic polymer (fine) particles, and the fine particles are present in a semi-bonded state that there are voids among some particles though some particles are in contact with one another since the thermoplastic polymer particles are electrodeposited on the support, in contrast to being coated. Therefore, in the image formation by heat fusion of fine particles upon scanning exposure to laser beams in the infrared region, the thermoplastic polymer (fine) particles have satisfactory heat-fusible properties and can ensure high image strength. In the unexposed areas (non-image areas), on the other hand, the fine particles are removed in aggregates of moderate sizes. So the fine particles in the unexposed areas can have better removability, or better developability, and can be removed using a fountain solution or ink on a printing machine. Thus, it becomes possible to make a lithographic printing plate generating no scumming and having a long press life.

The features and advantages brought by using electric charged fine particles as particulate high molecular polymer are as follows:

(1) The dispersion can be rendered stable, and consistent production can be achieved.

(2) Adhesion of particles to a substrate under an electric field becomes feasible by conferring charges on the particles (so that there is no need of using a high-precision coating apparatus).

(3) Electrodeposition enables stronger adsorption of particles to a substrate than mere coating.

(4) Interaction among particles electrodeposited on a substrate is stronger than that among particles coated simply on a substrate, and a state of contact is brought about among the electrodeposited particles. As a result, heat fusion occurs with efficiency and unexposed areas are removed in aggregates to result in enhancement of on-machine developability.

(5) Observations indicate that the particles have a three-dimensional structure by being piled up on the substrate by electrodeposition, and further they retain the three-dimensional structure after heat fusion by exposure. Therefore, the exposed part can have a large surface area and an advantage in ink receptivity.

(6) As the particulate polymer is dispersed in an electric insulating liquid (non-aqueous solvent), it is unnecessary to use water-soluble resins. As a result, the images formed have excellent waterproofing properties.

The dispersion of particulate high molecular polymer contains an electric insulating liquid (non-aqueous solvent) as a dispersion medium. As the electric insulating liquid, isoparaffin petroleum solvents are mainly used. These solvents have higher boiling points than general organic solvents, and they are free of a drawback of catching fire from static electricity, so they are safe from causing a disaster. In addition, as they have boiling points lower than aqueous dispersion media, they are favorable for air drying in the step of forming the particulate layer (image-forming layer).

Further, in forming an image-forming layer, there is no need for the printing method and printing machine of the present invention to use a generally required organic solvent which is comparatively expensive, deleterious to humans and flammable. And the printing method of the present invention makes it possible to reduce the number of processing steps for formation of lithographic printing plate images and the number of devices for these processing steps as well.

A further feature of the lithographic printing plate precursor of the present invention consists in that the support thereof has a water-receptive layer containing fine particles of anatase-type titanium dioxide.

In the case where an aluminum substrate having undergone usual treatments for rendering its surface water-receptive is used repeatedly, it sometimes occurs that sufficient restoration of water-receptivity to the substrate surface cannot be made by mere chemical or physical treatment, such as wiping with a cleaner. As a result, unevenness in water-receptivity of the substrate surface shows up and scumming generates. Occasionally, an increase in the number of times the substrate is used brings about gradual prominence of scumming.

By choosing as a water-receptive support used in the present invention a support provided with a water-receptive layer containing fine particles of anatase-type titanium dioxide having a photocatalytic function, it becomes feasible to regenerate the water-receptive support in a manner that, after conclusion of printing via usual printing operations, the plate surface is cleaned with chemical and/or physical treatment to remove the images on the plate surface and then irradiated with ultraviolet rays. As a result, it becomes possible to obtain scumming-free printed matters even when the water-receptive support is used repeatedly.

Fine particles of anatase-type titanium dioxide used in the present invention undergo optical excitation when they are irradiated with UV light, and thereby the particle surface can be made water-receptive and acquire a photocatalytic function. By carrying out irradiation with UV light during the plate-surface cleaning process, the scumming component remaining on the plate surface after cleaning undergoes oxidative decomposition and the water-receptivity at the support surface can be restored completely. Accordingly, scumming-free printings can be achieved even when the support is used repeatedly.

In the printing machine of the present invention, a plate surface-cleaning unit is installed in close proximity to a plate cylinder. In the interim between one printing work and the next printing work, the cleaning unit makes it feasible to wipe out the ink or fountain solution adhering to the surface of printing plate material (water-receptive support) at the conclusion of printing work, and subsequently to remove the toner image areas brought in close contact with and fixed to the plate surface by chemical and/or physical treatment as described hereinafter.

The image-forming layer is constituted mainly of uniform fine particles of a high molecular polymer. As these fine particles are attached to a support by electrodeposition, they are present in a semi-bonded state that there are voids among some particles though some particles are in contact with one another, as compared with the case where they are coated. Therefore, in the image formation by heat fusion of fine particles upon scanning exposure to laser beams in the infrared region, the fine particles of a high molecular polymer have satisfactory heat-fusible properties and can ensure high image strength. In the unexposed areas (non-image areas), on the other hand, the fine particles are removed in aggregates of moderate sizes. So the fine particles in the unexposed areas can have good removability, or good developability, and can be removed using a fountain solution or ink on a printing machine. Thus, it becomes possible to make a lithographic printing plate generating no scumming and having a long press life.

According to the printing method and printing machine of the present invention, both formation of an image-forming layer by electrodeposition and imagewise exposure are performed on the printing machine. Accordingly, the present invention can embody the so-called Computer-to-Cylinder (CTC) printing system capable of eliminating a plate-making step. Thus, much time and cost required for usual PS plate production become unnecessary, so printings are obtainable at low prices and on short lead times. Moreover, the plate replacement after conclusion of each printing work becomes unnecessary, so that there is no need to dispose of waste plates, and savings in time, labor and cost become possible.

The printing method of the present invention is characterized by comprising a step of forming an image-forming layer by applying an electric field between a water-receptive support mounted on a printing machine's plate cylinder and a dispersion containing at least thermoplastic polymer particles having multiple whisker-shaped projections, a light-to-heat converting agent and an electric charge modifier in an electric insulating liquid to cause electrodeposition of the thermoplastic polymer particles on the support, a step of subjecting the image-forming layer to imagewise exposure, and a step of carrying out printing after removal of non-image areas by applying ink or water or giving a rub. More specifically, the printing method of the present invention utilizes as an electrophotographic liquid developer (toner) a dispersion of particulate thermoplastic polymer having multiple whisker-shaped projections, performs electrode position of the particulate thermoplastic polymer on a water-receptive support mounted on a plate cylinder installed in the printing machine, thereby forming a photosensitive particulate layer (image-forming layer), produces negative images on the support by thermal fusion of the particles in areas exposed to laser beams, enables removal of the particles in areas not exposed to laser beams by application of a fountain solution or printing ink to these areas on the printing machine, and performs printing operations. After the printing operations are finished, the method of the present invention may optionally enable regeneration of the printing plate by wiping the plate surface with a plate cleaner, repetition of electrodeposition thereon and then performance of the printing operations again according to the aforementioned procedure.

It is one feature also that the formation of a particulate layer (image-forming layer) on a water-receptive support mounted on a printing machine's plate cylinder is attained by applying an electric field between a dispersion of particulate thermoplastic polymer having electric charge and the support to electrodeposit the fine particles on the support.

The dispersion of particulate thermoplastic polymer contains an electric insulating liquid (non-aqueous solvent) as a dispersion medium. As the electric insulating liquid, isoparaffin petroleum solvents are mainly used. These solvents have higher boiling points than general organic solvents, and they are free of a drawback of catching fire from static electricity, so they are safe from causing a disaster. In addition, as they have boiling points lower than aqueous dispersion media, they are favorable for air drying in the step of forming the particulate layer (image-forming layer).

Further, in forming an image-forming layer, there is no need for the printing method of the present invention to use a generally required organic solvent which is comparatively expensive, deleterious to humans and flammable. And the printing method of the present invention makes it possible to reduce the number of processing steps for formation of lithographic printing plate images and the number of devices for these processing steps as well.

A further feature of the printing method of the present invention consists in that, after the printing has been done via general printing steps, it is possible to clean the plate surface by chemical and/or physical treatment to remove the images therefrom, thereby effecting regeneration of the water-receptive support.

In a printing machine used in the printing method of the present invention, a plate surface-cleaning unit is installed in close vicinity to a plate cylinder. By doing so, in the interim between one printing work and the next printing work, it becomes feasible to wipe out the ink or fountain solution adhering to the surface of printing plate material (water-receptive support) at the conclusion of printing work, and subsequently to remove the toner image areas brought in close contact with and fixed to the plate surface by chemical and/or physical treatment as described hereinafter.

By performing both formation of an image-forming layer by electrodeposition and imagewise exposure on a printing machine, the printing method of the present invention can realize the so-called Computer-to-Cylinder (CTC) printing system capable of eliminating a plate-making step. Thus, much time and cost required for usual PS plate production become unnecessary, so printings are obtainable at low prices and on short lead times. Moreover, the plate replacement after conclusion of each printing work becomes unnecessary, so that there is no need to dispose of waste plates, and savings in time, labor and cost become possible.

### BRIEF DESCRIPTION OF DRAWINGS

FIG. 1 is a schematic diagram illustrating an example of a printing machine according to the present invention.

FIG. 2 is a schematic diagram illustrating an on-machine electrodeposition unit installed in the printing machine shown in FIG. 1.

The reference numerals in these figures show the following members, respectively.

1: Plate cylinder

2: Electrodeposition unit

3: Image drawing unit

4: Ink-and-water feed unit

5: Plate surface-cleaning unit

6: Blanket cylinder

7: Impression cylinder

8: Ultraviolet irradiation device

11: Water-receptive support

12: Printed matter

13: Image-forming layer

20: Electrodeposition head

21: Slit for electrodeposition solution supply

22: First slit for electrodeposition solution recovery

23: Second slit for electrodeposition solution recovery

24: Blade

25: Electrodeposition tank

26: Pump

27: DC power supply

### DETAILED DESCRIPTION OF THE INVENTION

Lithographic printing plate precursors according to the present invention are described below in detail.

In addition, printing methods and printing machines according to the present invention are also illustrated in detail below.

[Dispersion of Particulate High Molecular Polymer Having Electric Charge]

A dispersion of particulate high molecular polymer having electric charge (toner), which characterizes the lithographic printing plate precursor of the present invention and is used for forming an image-forming layer (heat-sensitive layer or photosensitive particulate layer), is described first.

The particulate high molecular polymer dispersion of the present invention contains at least a high molecular polymer, an electric charge modifier, a dispersant and a light-to-heat converting agent.

As described above, the lithographic printing plate precursor of the present invention comprises a water-receptive support having a water-receptive layer containing anatase-type particulate titanium dioxide and an image-forming layer provided on the support by applying an electric field between the support and a dispersion containing at least particulate high molecular polymer having electric charge, a light-to-heat converting agent and an electric charge modifier in an electric insulating liquid to cause electrodeposition of the particulate high molecular polymer on the support.

The anatase-type particulate titanium dioxide that is one of the characteristic constituents in the lithographic printing plate precursor of the present invention and contained in the water-receptive layer formed on a water-receptive support as described hereinafter, and the water-receptive layer are explained below.

The anatase-type particulate titanium dioxide used in the present invention is characterized in that its surface can have water-receptivity when undergoes optical excitation by irradiation with ultraviolet rays. Details on the phenomenon that the particle surface comes to have water-receptivity when irradiated with light are described in, e. g., Toshiya Watanabe, Ceramics, 31, 937 (1996). However, no application of this phenomenon to a support for lithographic printing plate precursors has been disclosed yet.

The titanium dioxide particles used in the present invention have the crystal form of anatase type and have a feature that they are optically excited by ultraviolet irradiation and their surfaces become water-receptive. The suitable average size of anatase-type titanium dioxide particles is from 5 to 500 nm, preferably from 5 to 100 nm. In such a size rage, the conversion into water-receptive surface by ultraviolet irradiation can be effected more appropriately.

Such anatase-type titanium dioxide particles are commercially available as a powder or a titania sol dispersion. For instance, commercial products thereof can be purchased from ISHIHARA SANGYO KAISHA LTD., TITANIUM INDUSTRY CO., LTD., SAKAI CHEMICAL INDUSTRY CO. ,LTD., Nippon Aerosil Co. ,Ltd. , and NISSAN CHEMICAL INDUSTRIES, LTD. The anatase-type titanium dioxide particles used in the present invention may contain other metal elements or oxides thereof. The expression “contain” as used herein is intended to include a state that the particle surface is coated with metal elements or oxides thereof or/and metal elements or oxides thereof are held inside the particles, and a state that the particles are doped with metal elements or oxides thereof.

Examples of metal elements which can be contained in the titanium dioxide particles include Si, Mg, V, Mn, Fe, Sn, Ni, Mo, Ru, Rh, Re, Os, Cr, Sb, In, Ir, Ta, Nb, Cs, Pd, Pt and Au. Details of such containment in anatase-type titanium dioxide particles are described, e.g., in JP-A-7-228738, JP-A-7-187677, JP-A-8-81223, JP-A-8-257399, JP-A-8-283022, JP-A-9-25123, JP-A-9-71437 and JP-A-9-70532. Asuitable proportion of those metal elements or oxides thereof is 10% or less, preferably 5% or less, to the total weight of anatase-type titanium dioxide particles.

In addition to the anatase-type titanium dioxide particles of the present invention, the water-receptive layer may contain other inorganic pigment particles. Examples of such inorganic pigments include silica, alumina, kaolin, clay, zinc oxide, calcium carbonate, barium carbonate, calcium sulfate, barium sulfate, magnesium carbonate and titanium dioxides having crystal forms other than that of anatase type. It is appropriate that these inorganic pigments be used in a proportion of less than 40 parts by weight, preferably 30 parts by weight or less, per 100 parts by weight of the anatase-type titanium dioxide of the present invention.

Resins usable in the water-receptive layer of the present invention are resin mixtures whose main components are resins having siloxane linkages (i.e., siloxane bonds) represented by the following formula (I):

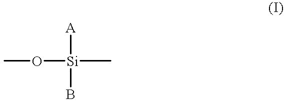

Examples of a siloxane linkage represented by the above formula include the following ones, and at least one of these linkages is present in each resin:

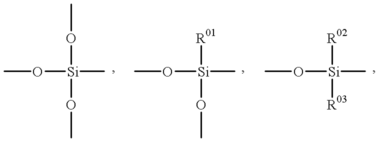

In the above formulae, R⁰¹, R⁰² and R⁰³ may be the same or different, and each of them represents a hydrogen atom, a hydrocarbon group or a heterocyclic group. And the hydrocarbon groups and the heterocyclic groups represented by A, B, R⁰¹, R⁰² and R⁰³ each are the same groups as R⁰ groups represented in the following formula (II).

It is advantageous to form the water-receptive layer from a dispersion containing at least one of anatase-type titanium dioxide particles and a silane compound represented by the following formula (II) in accordance with a sol-gel method:

(R⁰)ₙSi(Y)₄₋ₙ (II)

wherein R⁰ represents a hydrogen atom, a hydrocarbon group or a heterocyclic group, Y represents a hydrogen atom, a halogen atom, —OR¹, —OCOR² or —N(R³) (R⁴) (wherein R¹ and R² each represent a hydrocarbon group, and R³ and R⁴, which may be the same or different, each represent a hydrogen atom or a hydrocarbon group), and n represents 0, 1, 2 or 3.

Suitable examples of R⁰ in formula (II) include a hydrogen atom, a straight-chain or branched alkyl group with 1 to 12 carbon atoms which may be substituted [such as methyl, ethyl, propyl, butyl, pentyl, hexyl, heptyl, octyl, nonyl, decyl or dodecyl; which may have one or more substituents, and examples of such substituents include a halogen atom (chlorine, fluorine or bromine), a hydroxyl group, a thiol group, a carboxyl group, a sulfo group, a cyano group, an epoxy group, an —OR′ group (wherein R′ represents a hydrocarbon group, such as methyl, ethyl, propyl, butyl, heptyl, hexyl, octyl, decyl, propenyl, butenyl, hexenyl, octenyl, 2-hydroxyethyl, 3-chloropropyl, 2-cyanoethyl, N,N-dimethylaminoethyl, 2-bromoethyl, 2-(2-methoxyethyl)oxyethyl, 2-methoxycarbonylethyl, 3-carboxypropyl or benzyl), an —OCOR′ group, a —COOR′ group, a —COR′ group, an —N(R″)(R″) group (wherein R″ represents a hydrogen atom or has the same meaning as R′, and two R″s may be the same or different),an —NHCONHR′ group, an —NHCOOR′ group, a —Si(R′)₃ group, a —CONHR″ group and an —NHCOR′ group], a straight-chain or branched alkenyl group with 2 to 12 carbon atoms which may be substituted [such as vinyl, propenyl, butenyl, pentenyl, hexenyl, octenyl, decenyl or dodecenyl; which may have one or more substituents, and examples of such substituents include the same ones as described above for the alkyl groups] , an aralkyl group with 7 to 14 carbon atoms which may be substituted [such as benzyl, phenetyl, 3-phenylpropyl, naphthylmethyl or 2-naphthylethyl; which may have one or more substituents, and examples of such substituents include the same ones as described above for the alkyl groups], an alicyclic group with 5 to 10 carbon atoms which may be substituted [such as cyclopentyl, cyclohexyl, 2-cyclohexylethyl, 2-cyclopentylethyl, norbornyl or adamantyl, which may have one or more substituents, and examples of such substituents include the same ones as described above for the alkyl groups], an aryl group with 6 to 12 carbon atoms which may be substituted [such as phenyl or naphthyl; which may have one or more substituents, and examples of such substituents include the same ones as described above for the alkyl groups], and a heterocyclic group which contains at least one hetero atom selected from nitrogen, oxygen or sulfur and may have a condensed ring structure [examples of which include those containing as hetero rings a pyran ring, a furan ring, a thiophene ring, a morpholine ring, a pyrrole ring, a thiazole ring, an oxazole ring, a pyridine ring, a piperidine ring, a pyrrolidone ring, a benzothiazole ring, a benzoxazole ring, a quinoline ring and a tetrahydrofuran ring, wherein each of these rings may have one or more substitutents and examples of such substituents include the same ones as described above for the alkyl groups].

Suitable examples of Y in formula (II) include a halogen atom (such as fluorine, chlorine, bromine or iodine atom), an —OR¹ group, an —OCOR² group and an —N(R³) (R⁴) group. R¹ in the —OR¹ group represents an unsubstituted or substituted aliphatic group with 1 to 10 carbon atoms (with examples includingmethyl, ethyl, propyl, butoxy, heptyl, hexyl, pentyl, octyl, nonyl, decyl, propenyl, butenyl, heptenyl, hexenyl, octenyl, decenyl, 2-hydroxyethyl, 2-hydroxypropyl, 2-methoxyethyl, 2-(methoxyethyloxy)ethyl, 2-(N,N-diethylamino)ethyl, 2-methoxypropyl, 2-cyanoethyl, 3-methyloxypropyl, 2-chloroethyl, cyclohexyl, cyclopentyl, cyclooctyl, chlorocyclohexyl, methoxycyclohexyl, benzyl, phenetyl, dimethoxybenzyl, methylbenzyl and bromobenzyl groups).

R²in the —OCOR² group represents an aliphatic group having the same meaning as R¹, or an unsubstituted or substituted aromatic group with 6 to 12 carbon atoms (which include aryl groups described above for R⁰). R³ and R⁴ in the —N (R³) (R⁴) group may be the same or different, and each represents a hydrogen atom or an unsubstituted or substituted aliphatic group with 1 to 10 carbon atoms (which has the same meaning as R¹ in the —OR¹ group). Herein, it is preferable that the total number of carbon atoms contained in R³ and R⁴ be 16 or below.

Examples of a silane compound represented by formula (II) include methyltrichlorosilane, methyltribromosilane, methyltrimethoxysilane, methyltriethoxysilane, methyltriisopropoxysilane, methyltri-t-butoxysilane, ethyltrichlorosilane, ethyltribromosilane, ethyltrimethoxysilane, ethyltriethoxysilane, ethyltriisopropoxysilane, ethyltri-t-butoxysilane, n-propyltrichlorosilane, n-propyltribromosilane, n-propyltrimethoxysilane, n-propyltriethoxysilane, n-propyltriisopropoxysilane, n-propyltri-t-butoxysilane, n-hexyltrichlorosilane, n-hexyltribromosilane, n-hexyltrimethoxysilane, n-hexyltriethoxysilane, n-hexyltriisopropoxysilane, n-hexyltri-t-butoxysilane, n-decyltrichlorosilane, n-decyltribromosilane, n-decyltrimethoxysilane, n-decyltriethoxysilane, n-decyltriisopropoxysilane, n-decyltri-t-butoxysilane, n-octadecyltrichlorosilane, n-octadecyltribromosilane, n-octadecyltrimethoxysilane, n-octadecyltriethoxysilane, n-octadecyltriisopropoxysilane, n-octadecyltri-t-butoxysilane, phenyltrichlorosilane, phenyltribromosilane, phenyltri-methoxysilane, phenyltriethoxysilane, phenyltriisopropoxy-silane, phenyltri-t-butoxysilane, tetrachlorosilane, tetra-bromosilane, tetramethoxysilane, tetraethoxysilane, tetra-isopropoxysilane, tetrabutoxysilane, dimethoxydiethoxysilane, dimethyldichlorosilane, dimethyldibromosilane, diemthyldi-methoxysilane, dimethyldiethoxysilane, diphenyldichloro-silane, diphenyldibromosilane, diphenyldimethoxysilane, diphenyldiethoxysilane, phenylmethyldichlorosilane, phenyl-methyldibromosilane, phenylmethyldimethoxysilane, phenyl-methyldiethoxysilane, triethoxyhydrosilane, tribromohydro-silane, trimethoxyhydrosilane, triisopropoxyhydrosilane, tri-t-butoxyhydrosilane, vinyltrichlorosilane, vinyltri-bromosilane, vinyltrimethoxysilane, vinyltriethoxysilane, vinyltriisopropoxysilane, vinyltri-t-butoxysilane, tri-fluoropropyltrichlorosilane, trifluoropropyltribromosilane, trifluoropropyltrimethoxysilane, trifluoropropyltriethoxy-silane, trifluoropropyltriisopropoxysilane, trifluoro-propyltri-t-butoxysilane, γ-glycidoxypropylmethyl-dimethoxysilane, γ-glycidoxypropylmethyldiethoxysilane, γ-glycidoxypropyltrimethoxysilane, γ-glycidoxypropyltri-ethoxysilane, γ-glycidoxypropyltriisopropoxysilane, γ-glycidoxyproopyl-t-butoxysilane, γ-methacryloxypropyl-methyldimethoxysilane, γ-methacryloxypropylmethyl-diethoxysilane, γ-methacryloxypropyltrimethoxysilane, γ-methacryloxypropyltriisopropoxysilane, γ-methacryloxy-propyltri-t-butoxysilane , γ-aminopropylmethyldimethoxy-silane, γ-aminopropylmethyldiethoxysilane, γ-amino-propyltrimethoxysilane, γ-aminopropyltriethoxysilane, γ-aminopropyltriisopropoxysilane, γ-aminopropyltri-t-butoxy-silane, γ-mercaptopropylmethyldimethoxysilane, γ-mercapto-propylmethyldiethoxysilane, γ-mercaptopropyltrimethoxy-silane, γ-mercaptopropyltriethoxysilane, γ-mercapto-propyltriisopropoxysilane, γ-mercaptopropyltri-t-butoxy-silane, β-(3,4-epoxycyclohexyl)ethyltrimethoxysilane, and β-(3,4-epoxycyclohexyl)ethyltriethoxysilane.

In addition to a silane compound represented by formula (II), metal compounds capable of forming a film by a sol-gel method, such as compounds of Ti, Zn, Sn, Zr, Al and Ni, may be used in forming the water-receptive layer of the present invention. Examples of such metal compounds include Ti(OR⁵)₄ (wherein R⁵ represents a methyl, ethyl, propyl, butyl, pentyl or hexyl group), TiCi₄, Zn(OR⁵)₄, Zn(CH₃COCHCOCH₃)₂, Sn(OR⁵), Sn (CH₃COCHCOCH₃) ₄, Sn (OCOR⁵)₄, SnCl₄, Zr (OR⁵)₄, Zr (CH₃COCHCOCH₃) ₄, Al (OR⁵) ₃, and Ni (CH₃COO)₄.

In using the metal compounds as described above in addition to the silane compound, the amount used is in a range that the film formed by a sol-gel method can maintain sufficient uniformity and strength. The suitable ratio of the anatase-type particulate titanium dioxide to the resin having siloxane linkages in the water-receptive layer of the present invention is from 30/70 to 95/5, preferably from 50/50 to 80/20, by weight. As far as the ratio between these two ingredients is within the aforesaid range, the water-receptive layer formed can have satisfactory film strength and the surface thereof can get sufficient water-receptivity by ultraviolet irradiation. As a result, the printing plate made from the printing plate precursor of the present invention can provide a great number of printed matters with clear images and no stains in the printing operations.

As described above, it is advantageous to form the water-receptive layer of the present invention by a sol-gel method, and the sol-gel method adopted herein may be any of well-known sol-gel methods. Specifically, the water-receptive layer of the present invention can be formed using the methods described in detail in literatures, e.g., Sumino Sakihana, Sol-Gel ho no kagaku (Translated in English, it says “Science of Sol-Gel Methods”), Agune Shofusha (1988), and Seki Hirashima, Saishin Sol-Gel ho niyoru Kinousei Usumaku Seisei Gijutu (Translated in English, it says “Techniques of Forming Functional Thin Films by Latest Sol-Gel Methods”), Sogo Gijutu Center (1992).

As a solvent of a coating composition for the water-receptive layer of the present invention, water is used mainly, and water-soluble solvents are used together with water in order to inhibit the coating composition from precipitating upon preparation and render the coating composition homogeneous. Examples of such water-soluble solvents include alcohol compounds (such asmethanol, ethanol, propyl alcohol, ethylene glycol, diethylene glycol, propylene glycol, dipropylene glycol, ethylene glycol monomethyl ether, propylene glycol monomethyl ether and ethylene glycol monoethyl ether), ethers (such as tetrahydrofuran, ethylene glycol dimethyl ether, propylene glycol dimethyl ether and tetrahydropyran), ketones (such as acetone, methyl ethyl ketone and acetylacetone), esters (such as methyl acetate and ethylene glycol monomethyl monoacetate), and amides (such as formamide, N-methylformamide, pyrrolidone and N-methylpyrrolidone). These solvents may be used alone or as combinations.

For the purpose of promoting hydrolysis and polycondensation reaction of a silane compound represented by formula (II) and a metal compound selected from the above-described ones and used together with the silane compound, it is desirable to use an acidic or basic catalyst. Acid compounds or basic compounds may be used as such a catalyst as they are, or in a state of being dissolved in a solvent, such as water or alcohol. The catalyst solution has no particular restriction as to its concentration, but high concentrations show a tendency to increase the hydrolysis and polycondensation speeds. In the case of using a basic catalyst, however, high basic catalyst concentrations sometimes cause precipitation in sol solutions. So the suitable basic catalyst concentrations are 1N or below (on a water solution basis).

The acid or basic catalyst used therein has no particular species restriction. When there is necessity to use a catalyst in a high concentration, however, it is desirable to use a catalyst constituted of elements leaving almost no residues in crystal grains after sintering. Suitable examples of an acid catalyst include hydrogen halides such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of RCOOH is substituted with other elements or substituents, and sulfonic acids such as benzenesulfonic acid. Suitable examples of a basic catalyst include ammoniac bases such as aqueous ammonia, and amines such as ethylamine and aniline.

The coating composition thus prepared is made into a film by being coated on a support by any of well-known coating methods and then being dried. The appropriate thickness of the water-sensitive layer formed is from 0.2 to 10 μm, preferably from 0.5 to 8 μm. In this thickness range, the film formed can have uniform thickness and sufficient strength.

By utilizing the aforesaid resin having siloxane linkages and forming a film by the use of a sol-gel method in particular, the present invention can have advantages that the water-receptive layer formed has high film strength and titanium dioxide particles are in a state of highly homogeneous dispersion.

Through exposure to light under an ordinary handling condition after formation on a support by a coating method, the titanium dioxide-containing water-receptive layer of the present invention can get water-receptivity. When the water-receptive layer surface is stained by adsorption of trace amounts of organic substances in the air, there sometimes occurs insufficiency of water receptivity. Therefore, it is advantageous that UV irradiation is carried out after mounting a support on a printing machine and before performing electrodeposition of toner, thereby ensuring high and uniform water-receptivity.

In order to make full use of the effects of anatase-type particulate titanium dioxide in the present invention, it is desirable for the water-receptive layer to contain particulate titanium dioxide in a proportion of 30 to 95 weight %, preferably 50 to 80 weight %, and thereby the water-receptive layer surface can be covered with a sufficient amount of particulate titanium dioxide and can get the intended water-receptivity. When the proportion is lower than 30 weight %, the layer surface cannot always have sufficient water-receptivity; while, when the proportion is higher than 95 weight %, the layer tends to crumble.

(High Molecular Polymer)

As a high molecular polymer resin (covering agent) for the particulate high molecular polymer of the present invention, thermoplastic resins insoluble or swelling in carrier liquids can be used. These resins adhere to a light-to-heat converting agent or form a film around the agent, and thereby have an effect of promoting dispersion of the agent or an effect of improving the fixability of the agent. Examples of such resins include rubbers such as butadiene rubber, styrene-butadiene rubber and cyclized rubber, styrene resin, vinyltoluene resin, acrylic resin, methacrylic resin, copolymer resins derived from those resins, polyester resin, polycarbonate resin, polyvinyl acetate resin, and various kinds of alkyd resins. Of these resins, acrylic resin, methacrylic resin and acrylic-methacrylic copolymer resin are preferably used. This is because each of these resins permits easy change in softening point or solubilities in carrier liquids by changing the chain length of alkyl moiety in the ester group.

As high molecular polymer particles in the present invention, thermoplastic polymer particles having multiple whisker-shaped projections can be used. As examples of such particles, mention may be made of the particles disclosed in JP-A-61-180248. More specifically, thermoplastic resins of the type which are insoluble or swell in carrier liquids can be employed. These resins adhere to a light-to-heat converting agent or form a film around the agent, and thereby produce an effect of promoting dispersion of the agent or an effect of improving the fixability of the agent. Examples of such resins include rubbers such as butadiene rubber, styrene-butadiene rubber and cyclized rubber, styrene resin, vinyltoluene resin, acrylic resin, methacrylic resin, copolymer resins derived from those resins, polyester resin, polycarbonate resin, polyvinyl acetate resin, and various kinds of alkyd resins. Of these resins, acrylic resin, methacrylic resin and acrylic-methacrylic copolymer resin are preferably used. This is because each of these resins permits easy change in softening point or solubilities in carrier liquids by changing the chain length of alkyl moiety in the ester group.

These thermoplastic polymer particles having multiple whisker-shaped projections have no particular restrictions on their preparation method, but virtually the following three methods are usable.

More specifically, one method comprises dispersing or dissolving pigment particles in a thermoplastic polymer at a temperature of 65° C. to 100° C., cooling the plasticized material to obtain a sponge-form matter, and subsequently crushing and the sponge-form matter into small pieces and further grinding them. This method will be described in detail hereinafter.

Another method comprises dissolving one or more kinds of polymers in a non-polar dispersing medium together with pigment particles such as carbon black or an analog thereto, and subsequently gradually cooling the solution with stirring to form particles. The particles precipitated by cooling the solution are observed to have multiple whisker-shaped projections.

The third method comprises heating a polymer at a temperature higher than its melting point, and dispersing pigment particles in the molten polymer. In this method, a sponge-form matter is not formed, but the whisker-shaped projections are formed by severing the pigment-mixed thermoplastic resin.

(Electric Charge Modifier)

Electric charge modifiers usable in the present invention are well-known ones, with examples including metal salts of fatty acids, such as naphthenic acid, octenoic acid, oleic acid and stearic acid, metal salts of sulfosuccinic acid esters, the metal salts of oil-soluble sulfonic acids as disclosed in JP-A-45-556, JP-A-52-37435 and JP-A-52-37049, the metal salts of phosphoric acid esters disclosed in JP-A-45-9594, the metal salts of abietic acid or hydrogenated abietic acid disclosed in JP-B-48-25666 (the term “JP-B” as used herein means an “examined Japanese patent publication”), the calcium salts of alkylbenzenesulfonic acids disclosed in JP-B-55-2620, the metal salts of aromatic carboxylic or sulfonic acids as disclosed in JP-A-52-107837, JP-A-52-38937, JP-A-57-90643 and JP-A-57-139753, nonionic surfactants such as polyoxyethylated alkylamines, fats and oils such as lecithin and linseed oil, polyvinyl pyrrolidone, organic acid esters of polyhydric alcohol, the phosphate surfactants disclosed in JP-A-57-210345 and the sulfonic acid resins disclosed in JP-B-56-24944. In addition, the amino acid derivatives disclosed in JP-A-60-21056 and JP-A-61-50951 can be used, too. Specifically, these amino acid derivatives include compounds represented by the following formulae (1) or (2), and reaction mixtures prepared by reaction of amino acids with titanium compounds in organic solvents and subsequent reaction of the resulting reaction products with water:

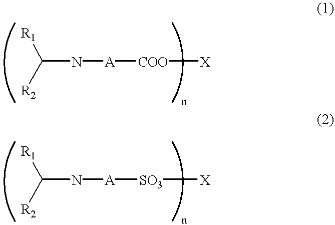

wherein R₁and R₂each represent a hydrogen atom, an unsubstituted alkyl group, a substituted alkyl group with 1 to 22 carbon atoms(containing as a substituent a dialkylamino group, an alkyloxy group or an alkylthio group), an unsubstituted aryl group, a substituted aryl group with 6 to 24 carbon atoms (containing as a substituent a dialkylamino group, an alkyloxy group, an alkylthio group, a chlorine atom, a bromine atom, a cyano group, a nitro group or a hydroxyl group), an aralkyl group, an acyl with 1 to 22 carbon atoms, alkylsulfonyl or alkylphosphonyl group, or an arylsulfonyl group with 6 to 24 carbon atoms, but they may be the same or different, and they may combine with each other to complete a ring, provided that both of R₁ and R₂ are not hydrogen atoms at the same time; A represents an unsubstituted alkylene group or a substituted alkylene group with 1 to 10 carbon atoms; X represents a hydrogen atom, a mono- to tetra-valent metal ion or a quaternary ammonium cation; and n is a positive integer.

Of these compounds, metal salts of naphthenic acid, metal salts of dioctylsulfosuccinic acid, lecithin and the amino acid derivatives described above are preferred over the others. In particular, zirconium, cobalt and manganese salts of naphthenic acid, calcium and sodium salts of dioctylsulfosuccinic acid and the metal salts of compounds represented by the foregoing formula (1) can be used to advantage. As to the metal salts of the compounds of formula (1), the titanium, cobalt, zirconium and nickel salts are especially suitable.

These electric charge modifiers may be used alone or as combinations.

(Dispersant)

Dispersants usable in the present invention are resins capable of enhancing the dispersibility of fine particles of a high molecular polymer having electric charge (referred to as “toner”, too), specifically resins capable of increasing the dispersibility of toner through dissolution or swelling in carrier liquids. Examples of such resins include rubbers such as styrene-butadiene rubber, vinyltoluene-butadiene rubber and butadiene-isoprene rubber, polymers of acrylic monomers containing long-chain alkyl groups such as 2-ethylhexyl(meth)acrylate, lauryl(meth)acrylate and stearyl (meth) acrylate, and copolymers of the above-described monomers and other monomers such as styrene, methyl (meth) acrylate, ethyl (meth) acrylate and propyl (meth) acrylate, including graft copolymers and block copolymers. Of these dispersants, synthetic rubber dispersants are highly effective. In particular, random and block copolymers of styrene and butadiene can be used to great advantage.

(Light-to-heat Converting Agent)

When images are formed in the lithographic printing plate precursor of the present invention by scanning exposure to laser beams, it is desirable to incorporate a light-to-heat converting agent, or an agent for converting light energy to heat energy, in a particulate high molecular polymer dispersion as a constituent of the printing plate precursor.

Any of substances capable of absorbing light, such as ultraviolet, visible, infrared or white rays, and converting it to heat can be incorporated as the light-to-heat converting agent. Examples of such substances, include dyes, carbon black, metal colloids, titanium black, metal carbide, borides, nitrides and nitrogen carbide powders. Especially preferred light-to-heat converting agents are dyes and pigments absorbing effectively infrared rays of wavelengths ranging from 760 to 1,200 nm, or metal powders and metal compound powders.

Additionally, these light-to-heat converting agents coated with the high molecular polymers as described above can be employed as the particulate high molecular polymers having electric charge. Herein, it is preferable to use carbon black as the light-to-heat converting agent.

[Method for Preparing Fine Particles]

The resin as described above for a covering agent is mixed with the light-to-heat converting agent as described above, and then fused at a temperature higher than the softening temperature of the covering agent and kneaded with a Bumbury's mixer, an extruder, a kneader or a three-roll mill, thereby preparing a mixture. In another manner, the resin as a covering agent is dissolved in a solvent having an affinity therefor, and then a light-to-heat converting agent is added to the resulting solution and further dispersed and kneaded by means of a dispersing and kneading machine, such as a ball mill, an attritor, a sand mill, a Bumbury's mixer, an extruder, a kneader or a three-roll mill. The kneaded matter thus obtained is dried, or added to a non-solvent to form a precipitate, thereby preparing a mixture. However, the method comprising melting and kneading steps is preferred over the other methods, because it can ensure good adhesion of the covering agent to the light-to-heat converting agent and can reduce desorption during the dispersing process and with a lapse of time.

Then, the thus obtained mixture is ground in a dry condition, and further dispersed together with a dispersant in a wet condition by means of a dispersing machine, such as a ball mill, an attritor, a paint shaker or a sand mill, thereby preparing a concentrated toner solution. This concentrated toner solution is added to a carrier liquid containing an electric charge modifier. Thus, a particulate high molecular polymer dispersion is obtained.

In the simplest method of other particulate toner preparation methods usable in the present invention, as briefly described hereinbefore, the first step is to plasticize a polymer containing the desired pigment in a certain amount by the use of a plasticizer and mix them till the resulting mixture becomes homogeneous. After thorough mixing, the mixed matter is taken out from a mill (i.e., grinder), and cooled. The cooled matter obtained has a sponge form. This sponge-form matter is required to have a hardness of at least 120, and the suitable hardness thereof is from 25 to 45. The mixing temperature is in the range of 65° C. to 100° C., preferably 90° C. The mixing time is in the range of 10 minutes to 3 hours, preferably about 90 minutes. The mixing step may be carried out using an appropriate mixing or compounding machine, such as a planetary mixer.

After cooling the mixture, the mixture is sliced into flakes, and further grinded with a rotoplex or a pin-type mill. The grinded matter is further fed into a friction mill, a disk-type grinder, a sand mill, an impeller-type friction mill or a vibration energy mill. The grinding with such a mill is performed for the purpose of forming a plurality of whisker-shaped projections on each toner particle while tearing relatively coarse grains asunder. This grinding purpose is distinct contrastingly from the conventional purpose of only reducing the particle size of toner. An important feature of this preparation method is to grind a composition under the wet condition.

(Concentration and Proportion)

The particle concentration (total concentration of a covering agent resin and a light-to-heat converting agent) is not particularly limited, but it is appropriate that the particle concentration be from about 0.1 to about 10 g/l, preferably from about 0.3 to about 1 g/l, in the case of a working solution, and from about 10 to 500 g/l in the case of a concentrated toner solution.

With respect to the proportion between the covering agent resin and the light-to-heat converting agent used in combination, it is appropriate to use about 0.1 to 20 parts by weight, preferably about 0.5 to 5 parts by weight, of the covering agent resin per 1 parts by weight of light-to-heat converting agent. And the dispersant is used in a proportion of about 0.1 to 10 parts by weight, preferably about 0.2 to 5 parts by weight, to 1 parts by weight of light-to-heat converting agent. Further, the electric charge modifier is used in a concentration of about 1×10⁻⁴ to 1 mole/l, preferably about 1×10⁻³ to 1×10⁻¹ mole/l, in the case of a concentrated toner solution; while in the case of a diluted toner solution the electric charge modifier concentration is from about 1×10⁻⁶ to 1×10⁻² mole/l, preferably about 1×10⁻⁵ to 1×10⁻³ mole/l.

The electric insulating liquid used in the present invention can be chosen from various well-known ones. As it is necessary for electrostatic latent images to be not impaired during the development-processing, it is desirable to choose a non-aqueous solution having an electric resistance of at least 10⁹ Ω·cm and a permittivity of 3 or less. In addition, it is necessary to choose electric insulating liquids in which the covering agent used has low solubility. In general, aliphatic hydrocarbons, alicyclic hydrocarbons, aromatic hydrocarbons, halogenated hydrocarbons and polysiloxanes can be used as electric insulating liquids. In view of volatility, stability, toxicity and bad smell, petroleum solvents of isoparaffin series are suitably used. Examples of petroleum solvents of isoparaffin series include Isopar G, Isopar H, Isopar L and Isopar K (produced by Exxon Corp.), and Shellsol 71 (produced by Shell Oil Company.

The particulate high molecular polymers used in the present invention can be subjected to heating treatment for the purpose of improving storage stability and sedimentation properties of particles. As the heating treatment condition, it is suitable to heat the particles at a temperature ranging from the temperature lower by 20° C. than the softening start point of a high molecular resin used for the particles to a temperature within the softening temperature range of the high molecular resin.

[Support]

Examples of a material usable as the support of the present invention include paper, synthetic paper, synthetic resin-laminated paper (such as a polyethylene-, polypropylene- or polystyrene-laminated paper), a plastic film (such as a film of polyethylene terephthalate, polycarbonate, polyimide, nylon or cellulose triacetate), a sheet metal (such as a sheet of aluminum, aluminum alloy, lead, iron or copper), or paper or plastic film on which a metal as described above is laminated or vapor-deposited. Of these materials, an aluminum sheet, plastic films, paper and synthetic paper are preferred over the others. In addition, a composite sheet prepared by laminating an aluminum sheet on a polyethylene terephthalate film is also preferable. Of all those preferred materials, an aluminum sheet and plastic films are most favorable. In particular, an aluminum sheet is used to advantage. When a hydrophobic material like a plastic film is used, the material can be rendered water-receptive by providing thereon a water-receptive subbing layer (described hereinafter).

Further, the case of using an aluminum sheet as the support of the present invention is explained below.

An aluminum sheet is subjected to surface treatment, such as treatment for roughening the sheet surface (graining treatment) or imparting water-receptivity to the sheet surface, if needed. The surface-roughening treatment can be effected by an electrochemical graining method (e.g., a method of graining an aluminum sheet immersed in a hydrochloric or nitric acid electrolytic solution by passing an electric current therethrough), and/or a mechanical graining method (e.g., a wire brush-graining method of scratching the surface of an aluminum sheet with a metal wire; a ball-graining method of graining the surface of an aluminum sheet with abrasive balls and an abrasive; or a brush-graining method of graining the surface of an aluminum sheet with a nylon brush and an abrasive) Then, the aluminum plate having undergone the graining treatment as described above is chemically etched with an acid or alkali. The etching with an alkali is preferred from an industrial viewpoint. Examples of an alkali agent usable for the etching include sodium carbonate, sodium aluminate, sodium metasilicate, sodium phosphate, sodium hydroxide, potassium hydroxide and lithium hydroxide. The suitable concentration of an alkali solution is from 1 to 50 weight %. The appropriate temperature for alkali treatment is from 20° C. to 100° C. Further, it is advantageous to control the treatment conditions so that the amount of aluminum dissolved falls within the range of 5 to 20 g/m².

After alkali etching, the aluminum sheet is generally washed with an acid in order to remove smuts remaining on the surface. Examples of an acid usable therefor include nitric acid, sulfuric acid, phosphoric acid, chromic acid, hydrofluoric acid and hydroborofluoric acid. The desmut treatment after electrochemical surface roughening treatment can be carried out by any of well-known methods, e.g., a method of bringing the desmutted aluminum sheet into contact with sulfuric acid ranging in concentration from 15 to 65 weight % at a temperature of 50 to 90° C.

The thus surface-roughened aluminum sheet can be subjected to anodic oxidation treatment or chemical conversion treatment, if desired. The anodic oxidation treatment can be effected by any of well-known methods. Specifically, a direct or alternating current is fed to an aluminum sheet in an acid solution and thereby an aluminum oxide film (due to an anodic oxidation) is formed on the aluminum sheet surface. Examples of an acid used therein include sulfuric acid, phosphoric acid, chromic acid, oxalic acid, sulfamic acid and benzenesulfonic acid. The suitable conditions for anodic oxidation vary by electrolyte used. In general, however, it is appropriate that the electrolyte concentration be from 1 to 80 weight %, the electrolyte temperature be from 5 to 70° C., the current density be from 0.5 to 60 amperes/dm², the voltage be from 1 to 100 V, and the electrolysis time be from 10 to 100 seconds.

Especially preferred anodic oxidation methods are a method of performing anodic oxidation in sulfuric acid at a high current density, and a method of performing anodic oxidation by using phosphoric acid as an electrolytic cell. After the anodic oxidation treatment, the aluminum sheet maybe subjected to treatment with an alkali metal silicate (e.g., by immersing the aluminum sheet in an aqueous solution of sodium silicate. Further, a subbing layer may be provided on the aluminum support surface in order to improve adhesion between the aluminum support and a curable layer and printing properties.

[Subbing Layer]

In addition to the aluminum support as described above, a support whose water-receptivity at the surface is not sufficient (e.g., a plastic film) may also be coated with a water-receptive layer.

Examples of an ingredient which can constitute the subbing layer, include a polymer (such as gelatin, casein, polyvinyl alcohol, ethyl cellulose, phenol resin, styrene-maleic acid resin or polyacrylic acid), an amine (such as monoethanolamine, diethanolamine, triethanolamine or tripropanolamine) and hydrochloride, oxalate or phosphate thereof, a monoaminomonocarboxylic acid (such as aminoacetic acid or alanine), an oxyamino acid (such as serine, threonine or dihydroxyethylglycine), a sulfur-containing amino acid (such as cysteine or cystine), a monoaminodicarboxylic acid (such as aspartic acid or glutamic acid), a diaminomonocarboxylic acid (such as lysine), an aromatic nucleus-containing amino acid (such as p-hydroxyphenylglycine, phenylalanine or anthranyl), an aliphatic aminosulfonic acid (such as sulfamic acid or cyclohexylsulfamic acid), and a (poly) aminopolyacetic acid (such as ethylenediamine-tetraacetic acid, nitrilotriacetic acid, iminodiacetic acid, hydroxyethyliminodiacetic acid, hydroxyethylethylene-diamineacetic acid, ethylenediaminediacetic acid, cyclo-ethylenediaminetetraacetic acid, diethylenetriaminepenta-acetic acid or glycoletherdiaminetetraacetic acid). When the compounds as described above have acid groups, part or all of the acid groups may form a salt or salts (e.g., sodium, potassium or ammonium salt or salts). Two or more of the ingredients described above can be used in combination, too.

Additionally, when the support used is a plastic film, it is advantageous to add water-receptive fine particles (e.g., silica powder) to a water-receptive subbing layer in place of graining treatment in the case of an aluminum support.

[Production of Lithographic Printing Plate Precursor]

A lithographic printing plate precursor is produced by forming an image-forming layer (heat-sensitive layer) on a support having received the aforementioned water-receptivity imparting treatment or a substrate having the aforementioned subbing layer on a support having received such treatment.

The lithographic printing plate precursor of the present invention is characterized in that the image-forming layer (heat-sensitive layer) is formed by applying an electric field between the support and the foregoing electric charged particulate high molecular polymer dispersion (particulate thermoplastic polymer dispersion) to cause electrodeposition of the particulate high molecular polymer on the support or the substrate. Specifically, the image-forming layer can be formed using various methods similar to the electrodeposition (by electric field application) of toner particles in an electrophotographic liquid developer comparable to an electric charged particulate high molecular polymer dispersion (particulate thermoplastic polymer dispersion) which is caused by taking advantage of electric charge of the toner particles.

To be more specific, the electrodeposition can be effected by the following methods.

(Immersion Method)

A substrate is immersed in an electrodeposition solution, and a counter electrode is set at a given distance from the substrate. Then, a voltage is applied between the substrate and the counter electrode for a fixed period of time.

(Conveyance Liquid-Feeding Method)

While feeding an electrodeposition solution between a substrate wound around a roller and a roller-shaped counter electrode, an electric field is applied thereto and electrodeposition is performed continuously by conveying the substrate.

Distance between electrodes: 0.1 to 50 mm (preferably 1 to 10 mm)

Applied voltage: 100 to 5,000 V

Amount electrodeposited: 0.1 to 2 g

After electrodeposition, the carrier liquid of fine particles is removed. As a method for removal of the carrier liquid, air knife squeegee, corona squeegee or roller squeegee can be adopted.

In the manner as described above, the lithographic printing plate precursor of the present invention can be produced.

[Platemaking Method]

Next, a method of making a lithographic printing plate from the aforementioned printing plate precursor is illustrated.

In subjecting the printing plate precursor of the present invention to imagewise exposure, any light sources can be used as far as they can emit actinic rays. Suitable light sources are those emitting light of wavelengths in the red to infrared region. As examples of a laser light source usable therein, solid-state laser capable of emitting infrared rays with wavelengths of 760 to 1,200 nm, semiconductor laser and YAG laser are exemplified. In addition, excimer laser (XeF), He—Cd laser, N₂ laser, external resonator-type Fourth-HG using the second harmonic obtained by LD excited Nd:YAG laser internal resonator-type SHG and BBO crystal, and Q switch-operated LD excitation solid-state laser are also exemplified. Examples of a suitable light source other than laser devices include a xenon discharge lamp, a mercury lamp, a tungsten lamp, a tungsten-halogen lamp, a xenon arc lamp and a fluorescent lamp. Of these light sources, light sources capable of emitting rays including infrared rays are preferred.

In drawing images, either a current exposure system or a scanning exposure system may be employed. In the case of using a current exposure light source, the appropriate exposure amount varies with illuminance of the light source used. In general, however, it is appropriate that the current exposure intensity before modulation with images for printing be from 0.1 to 10 J/cm², preferably 0.1 to 1 J/cm². When the support is transparent, exposure can be carried out from the rear side of the support via the support. The exposure time can be chosen from a wide range so far as the necessary amount of exposure is secured. In general, it is appropriate that the exposure time be chosen from the range of 0.01 millisecond to 10 minutes, preferably from 0.01 millisecond to minute, and the illuminance of exposure be adjusted so as to attain the foregoing exposure intensity.

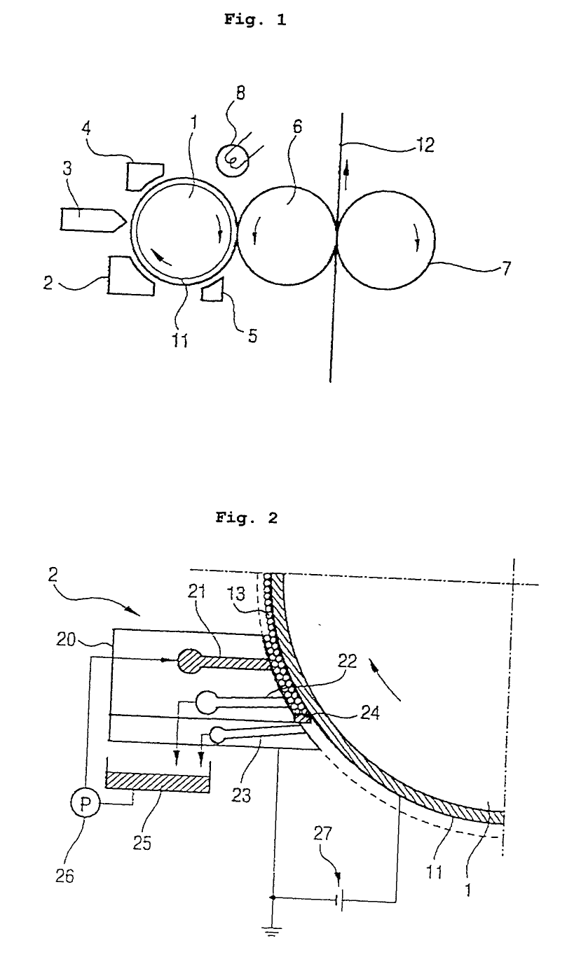

Further explanations are made on the basis of FIG. 1 and FIG. 2 showing a printing section of the lithographic printing machine of the present invention. FIG. 1 is a schematic diagram illustrating an example of an apparatus for performing on the present printing machine formation of an image-forming layer, direct drawing of images and platemaking. The sheet-form or web-form printing paper 12 (on which printing is done) is nipped between an impression cylinder 7 and a blanket cylinder 6. The blanket cylinder is in contact with a cylindrical plate cylinder 1, and it is a means of transferring inked images described hereinafter from the plate cylinder 1 onto the printing paper 12. Around the perimeter of the plate cylinder 1, a water-receptive support 11 is mounted. As the water-receptive support 11, paper, plastic film or metal sheet the surface of which has undergone water receptivity-imparting treatment can be used. For forming a particulate layer 13 (image-forming layer) around the perimeter of the water-receptive support 11 by electrodeposition of an electric charged dispersion (toner), an electrodeposition unit 2 installed in close proximity of the plate cylinder 1 is used.

After the image-forming layer 13 is formed on the water-receptive support 11, the surface of the layer 13 undergoes infrared-laser scanning exposure based on digital data of images to be printed by means of an image drawing unit 3 (image formation unit) installed in close proximity of the plate cylinder 1, thereby effecting image exposure in exact registration. Thus, an image pattern is formed, which is constituted of ink-receiving areas (hydrophobic areas of thermally fused particulate high molecular polymer) and ink-repelling areas (hydrophilic areas of particulate high molecular polymer remaining unfused).

While forming images, the printing machine is placed in the “off” mode of printing operation. More specifically, the plate cylinder 1 is not in contact with any cylinders in the “off” mode of printing operation. At the conclusion of the image formation by the use of the image drawing device 3, the printing machine is switched to the “on” mode of printing operation, and the image-drawn surface of the image-forming layer 13 on the support 11 is subjected to inking in the usual offset or water-free offset mode by the use of an ink-water feed device 4 installed in close proximity of the plate cylinder 1.

The unexposed non-image areas have good removability (developability) because the fine particles are present in aggregates of moderate sizes, so the removal thereof can be done on the printing machine by the use of a fountain solution or ink at the initial stage of a printing work.

Further, a plate surface-cleaning unit 5 is installed in close proximity of the plate cylinder 1. The plate surface-cleaning unit 5 wipes out most of the ink and water left on the toner images-formed image-forming layer 13 and the water-receptive support 11 after the previous printing work, and then removes the plate surface-deposited and fixed toner image areas by chemical and/or physical treatment. The term “chemical treatment” as used herein means that the plate surface having toner image areas is coated with or immersed in a chemical substance or its solution (chemical treatment solution) in which the toner resin can swell and/or dissolve. On the other hand, the term, “physical treatment” is defined as treatment for making a new surface reveal itself physically, e.g., by scraping away the toner image areas on the plate surface.

The plate surface-cleaning unit 5 is similar to a well-known “blanket washer” with which a modern printing machine is equipped to clean a blanket cylinder during intervals between printing works, but different from such a blanket washer in that there are cases where the addition of a chemical treatment solution as described below is required for dissolving most of images formed of the image-forming layer 13 on the plate cylinder 1.

Examples of the foregoing chemical treatment solution include ethers such as tetrahydrofuran and triethylene glycol dimethyl ether, aromatic solvents such as toluene, paraffinic hydrocarbons, ketones such as methyl ethyl ketone, dimethyl sulfoxide, and dimethylformamide. These organic solvents may be used alone, or as mixtures of two or more thereof, or as solutions diluted with diluents.

In addition, aqueous solutions containing salts, such as sulfates, phosphates, polyphosphates, silicates, organic phosphonates and oxalates, surfactants, water-soluble high molecular compounds, humectants, or organic solvents having ink-dissolving properties can be used as chemical treatment agents. As to the pH, it doesn't matter whether such aqueous solutions are acidic or alkaline.

FIG. 2 is a schematic diagram illustrating an on-machine electrodeposition unit 2 mounted on a cylindrical plate cylinder 1 of the printing machine of the present invention. The electrodeposition unit 2 is, as described above, a device for forming a particulate layer (image-forming layer) 13 by continuously performing electrodeposition of an electric charged particles (toner) dispersed in an electrodeposition solution by applying an electric field (direct current source 27) between the water-receptive support 11 wound around the perimeter of the cylindrical plate cylinder 1 and a counter electrode (electrodeposition head) 20 while feeding the electrodeposition solution from a slit 21 to the support surface and, at the same time, rotating the plate cylinder 1.

As shown in FIG. 2, the electrodeposition unit 22 is composed of an electrodeposition solution tank 25, a pump 26, an electrodeposition head 20, a blade (or roller) 24, an electrodeposition solution feed slit 21, a first slit 22 for electrodeposition solution recovery and a second slit 23 for electrodeposition solution recovery, and configured so as to enable application of a DC voltage between the electrodeposition head 20 and the water-receptive support 11 placed on the plate cylinder. The appropriate space between the water-receptive support 11 and the electrodeposition head 20 is from 1 to 20 mm. The suitable voltage applied is from 100 to 5,000 V, and the suitable amount of toner electrodeposited is from 0.1 to 2 g. The electrodeposition head 20 may be installed directly in a printing machine, or may have a structure independent of a printing machine and be placed on the printing machine at the time of use.

After electrodeposition, the carrier liquid of fine particles is removed. As a method for removal of the carrier liquid, air-knife squeegee, corona squeegee or roller squeegee can be adopted. The carrier liquid removed is recovered via first and second slits 22 and 23 for electrodeposition solution recovery.

[Image Drawing Method]

Drawing for image formation in the printing method of the present invention is described below.

By an image drawing unit (image-forming unit) 3 installed in close proximity of the plate cylinder 1, the surface of the image-forming layer 13 provided on the water-receptive support 11 is subjected to infrared laser scanning exposure based on the digital data to be printed to form image areas in exact registration.

For imagewise exposure of the image-forming layer 13, any light sources can be employed as far as the sources emit actinic rays. Suitable light sources include sources emitting light of wavelengths ranging longer wavelengths in the visible region to those in infrared region. Examples of a laser light source usable therein, include solid-state laser capable of emitting infrared rays with wavelengths of 760 to 1,200 nm, semiconductor laser and YAG laser. In addition, excimer laser (XeF), He—Cd laser, N₂ laser, external resonator-type Fourth-HG using the second harmonic obtained by LD excited Nd:YAG laser internal resonator-type SHG and BBO crystal, and Q switch-operated LD excitation solid-state laser are also exemplified. Examples of a suitable light source other than laser devices include a xenon discharge lamp, a mercury lamp, a tungsten lamp, a tungsten-halogen lamp, a xenon arc lamp and a fluorescent lamp. Of these light sources, light sources capable of emitting rays including infrared rays are preferred.

In drawing images, either a current exposure system or a scanning exposure system may be employed. In the case of using a current exposure light source, the appropriate exposure amount varies with illuminance of the light source used. In general, however, it is appropriate that the current exposure intensity before modulation with images for printing be from 0.1 to 10 J/Cm², preferably 0.1 to 1 J/cm². When the support is transparent, exposure can be carried out from the rear side of the support via the support. The exposure time can be chosen from a wide range so far as the necessary amount of exposure is secured. In general, it is appropriate that the exposure time be chosen from the range of 0.01 millisecond to 10 minutes, preferably from 0.01 millisecond to 1 minute, and the illuminance of exposure be adjusted so as to attain the foregoing exposure intensity.

Now, the present invention will be illustrated in more detail by reference to the following examples which are not to be considered as limiting on or determinative of the scope of the present invention.

### EXAMPLE I-1

(Preparation of Particulate High Molecular Polymer)

One parts by weight of carbon black (#40, a product of MITSUBISHI CHEMICAL CORPORATION) and 2 parts by weight of synthesized stearyl methacrylate-methyl methacrylate (1:9 by mole) copolymer were mixed, and fused and kneaded at 120° C. for 30 minutes by means of a 3-rod roll mill. After cooling to room temperature, the thus obtained matter was ground coarsely and then finely by means of a hammer mill and a pin-type mill respectively.

This ground matter was dispersed so to have the following composition.

(Composition of Particulate High Molecular Polymer Dispersion)

Ground matter described above 3 pts.wt.

5 weight % solution of Sorprene 1205

(a product by ASAHI KASEI CORPORATION) 20 pts.wt.

In preparing the dispersion, the ground matter was dispersed preliminarily by means of an attritor, and then fully dispersed for 2 hours by using a super mill under a condition of a peripheral speed of 10 m/sec. The concentration of solids in the thus prepared dispersion was 13 wt %, and the temperature during the dispersion process was kept at 35° C.

This dispersion was subjected to the following treatments.

This dispersion was diluted with Isopar G so that the concentration thereof was reduced to half, and therein was incorporated an electric charge modifier corresponding to the case where R₁ was n-C₈H₁₇, R₂ was n-C₁₃H₂₇CO, X was Ni, A was C₂H₄ and n was 2 in formula (1) in an amount of 1×10⁻⁴ moles per gram of toner particles. The resulting dispersion was subjected to heating treatment at 50° C. for 3 days. During the heating treatment, the dispersion didn't undergo any stirring operation. The charge quantity was 35 mV/cm, measured with the apparatus disclosed in JP-A-57-58176. The particle size was 0.46 μm, measured with a particle analyzer CAPA 500 made by Horiba Ltd. Further, the dispersion obtained was diluted with Isopar G so that it contained particles in a concentration (on a solid content) of 1 g/liter.

(Preparation of Aluminum Support)

The surface of a 0.24 mm-thick aluminum sheet based on JIS-A-1050 was grained using a nylon brush and an aqueous suspension of purmice stone (400 mesh), and washed thoroughly with water. This grained sheet was etched by 60-second immersion in a 10% aqueous solution of sodium hydroxide kept at 70° C., and washed with running water. The etched sheet was neutralized and rinsed with a 20% aqueous solution of nitric acid, and further washed with water. Then, the thus processed sheet underwent electrolytic treatment for roughening the surface thereof, wherein a 1 weight % aqueous nitric acid solution containing 0.5 weight % of aluminum nitrate was used as an electrolyte and an alternating current of rectangular-wave form was applied under a condition that the voltage at the anode was 12.7 V, the ratio of the quantity of electricity at the cathode to that at the anode was 0.9 and the quantity of electricity at the anode was 160 Coulomb/dm². The surface roughness of the thus treated aluminum sheet was 0.6 μm (expressed in terms of Ra). Subsequently thereto, the aluminum sheet was immersed in a 1 weight % aqueous solution of sodium hydroxide for 30 seconds at 40° C., and then treated with a 30 weight % aqueous solution of H₂SO₄ for 1 minute at 55° C. Furthermore, the thus treated aluminum sheet was anodized using a direct current in a 20 weight % aqueous solution of H₂SO₄ under a condition of a current density of 2 A/dm², thereby forming an anodic coating at a coverage of 2.5 g/dm². The aluminum sheet thus anodized was washed and dried to prepare a support.

The support obtained was immersed in a 2.5 weight % aqueous solution (pH: 11.2) of disodium trisilicate (No. 3) (SiO₂: 28 to 30 weight %, Na₂O: 9 to 10 weight %, Fe: 0.02 weight % or less) for 13 seconds at 70° C., and then washed with water. The silicate coverage determined by fluorescent X-ray analysis was 10 mg/M².

The aluminum support thus prepared was immersed in the particulate high molecular polymer dispersion prepared in the foregoing manner, and a negative counter electrode was placed in the dispersion at a distance of 1 cm from the aluminum support used as a positive electrode. And a direct voltage of 2,000 V was applied between the positive electrode and the negative electrode to form 0.6 g/m² of electro-deposit of the particulate high molecular polymer on the support. This electro-deposit on the support was air-dried to produce a lithographic printing plate precursor. This printing plate precursor was exposed to semiconductor laser emitting infrared radiation of wavelength of 830 nm.

Without undergoing development, the image-drawn lithographic printing plate precursor was mounted on the cylinder of a printing machine (TOKO 820, made by Tokyo Koku Keiki K.K.), and subjected to printing operations using a fountain solution (IF201 produced by Fuji Photo Film Co., Ltd.) and printing ink (GEOS ink produced by Dai-Nippon Ink & Chemicals Inc.). The thus made printing plate attained scumming-free printing on the 50th-printed sheet after the beginning of printing operations, and enabled production of 8,000 sheets of good-quality printed matter.

### EXAMPLES I-2 TO I-4

Electro-deposits of particulate high molecular polymers were each formed on the aluminum support, then subjected to laser exposure, and further to printing operations in the same manner as in Example I-1, except that the stearyl methacrylate-methyl methacrylate (1:9 by mole) copolymer used in Example I-1 was replaced by the polymers shown in Table I-1 respectively and the heating treatment was carried out at temperatures set forth in Table I-1 respectively.

TABLE I-1

| | | | Number of | |
|---|---|---|---|---|
| | | | sheets | |
| | | | printed | Number of |
| | | | before | good- |
| | | Temperature | scumming- | quality |
| | High molecular | for heating | free | printed |
| Example | polymer | treatment | printing | sheets |
| I-2 | Synthesized | 60° C. | 50 | 8,000 |
| | methyl | | | |
| | metahcrylate | | | |
| | stearyl | | | |
| | methacrylate | | | |
| | (95:5 by mole) | | | |
| | copolymer | | | |
| I-3 | Polystyrene | 60° C. | 50 | 7,500 |
| | resin | | | |
| | (Picolastic | | | |
| | D-150, produced | | | |
| | by Esso) | | | |
| I-4 | Vinyltoluene-but | 40° C. | 50 | 8,000 |
| | adiene copolymer | | | |
| | (Pliolite VT-L, | | | |
| | produced by | | | |
| | Goodyear) | | | |

As described above, an image-forming layer (heat-sensitive layer) to constitute the lithographic printing plate precursor of the present invention is formed on a support by applying an electric field between the support and a dispersion of electric charged particulate high molecular polymer to cause electrodeposition of the particulate high molecular polymer on the support by utilizing its electric charge. As a result, the image-forming layer is constituted mainly of uniform fine particles of high molecular polymer. As these fine particles are attached to a support by electrodeposition, they are present in a semi-bonded state, as compared with the case where they are coated. Therefore, in the image formation by heat fusion of fine particles upon scanning exposure to laser beams in the infrared region, the fine particles of high molecular polymer have satisfactory heat-fusible properties and can ensure high image strength. In the unexposed areas as non-image areas, on the other hand, the fine particles are removed in aggregates of moderate sizes. So the fine particles in the unexposed areas can have good removability, or good developability, and can be removed using a fountain solution or ink on a printing machine. Thus, the lithographic printing plate made from the printing plate precursor of the present invention enables scumming-free printing and can have a long press life.

In addition, the printing plate precursor of the present invention has an advantage that it enables platemaking by simple development-processing with water, or it can be mounted in a printing machine without undergoing any development-processing and subjected directly to platemaking and subsequent printing operations.

### EXAMPLE II-1

A particulate high molecular polymer dispersion was prepared in the same manner as in Example I-1.

The dispersion thus prepared was subjected to the same treatment as in Example 1-1.

An aluminum support was prepared in the same manner as in Example I-1.

The support prepared was immersed in a 2.5 weight % aqueous solution (pH: 11.2) of disodium trisilicate (No. 3) (SiO₂: 28 to 30 weight %, Na₂O: 9 to 10 weight %, Fe: 0.02 weight % or less) for 13 seconds at 70° C., and then washed with water. The silicate coverage determined by fluorescent X-ray analysis was 10 mg/M².

The water-receptive aluminum support thus prepared was mounted on the plate cylinder of an offset printing machine made by Tokyo Koku Keiki K.K. Further, as shown in FIG. 2, an electrodeposition unit was placed at a distance of 5 mm from the aluminum support. The aluminum support was used as a positive electrode, and a direct voltage of 2,000 V was applied between the positive electrode and the electrodeposition unit.

Specifically, the particulate high molecular polymer dispersion was placed in an electrodeposition tank, and fed to a gap between the electrodeposition unit and the aluminum support by means of a pump. The aluminum support was set as a positive electrode and the electrodeposition unit was set as a negative electrode. And a direct voltage of 2,000 V was applied between the positive electrode and the negative electrode, thereby forming on the support a 0.6 g/m² of electro-deposit of the particulate high molecular polymer. The electrolytic deposit was exposed to semiconductor laser emitting 830 nm infrared radiation. Without development after exposure, the printing was done by using a fountain solution (IF201 produced by Fuji Photo Film Co., Ltd.) and printing ink (GEOS ink produced by Dai-Nippon Ink & Chemicals Inc.). The thus made printing plate attained scumming-free printing on the 50th-printed sheet after the beginning of printing operations, and enabled production of 10,000 sheets of good-quality printed matter.

### EXAMPLE II-2

In accordance with the placement as shown in FIG. 1, a plate surface-cleaning unit 5 having waste impregnated with Ultra Plate Cleaner (produced by A.B.C. Chemical Co., Ltd.) was disposed. By the use of this unit, the ink and the image areas left on the plate surface after the printing operations in Example II-1 were removed and dried to regenerate the water-receptive support. Then, the particulate high molecular polymer was electrodeposited again on the regenerated water-receptive support, and the printing plate precursor thus obtained was subjected to laser exposure and subsequently to printing operations in the same manners as in Example II-1. As a result, good-quality printed matters having sufficient densities in the image areas and no stains in the non-image areas were obtained.

As described above, the printing method and machine of the present invention are characterized in that the formation of a particulate layer (image-forming layer) on a water-receptive support mounted on a printing machine's plate cylinder is performed by applying an electric field between the support and a dispersion of particulate high molecular polymer having electric charge to cause electrodeposition of the fine particles on the support. The dispersion of particulate high molecular polymer contains an electric insulating liquid as a dispersion medium, and the main component of the electric insulating liquid used is an isoparaffin petroleum solvent. Such a solvent has a higher boiling point than general organic solvents, and it is free of a drawback of catching fire from static electricity, so it is safe from causing a disaster. In addition, the formation of the image-forming layer of the present invention does not require deleterious and flammable organic solvents hitherto used for forming image-forming layers. Further, the printing method of the present invention makes it possible to reduce the number of processing steps for image formation in lithographic printing plate and the number of devices for these processing steps as well.

The other feature of the printing method and printing machine of the present invention consists in that a plate surface-cleaning unit is installed in close proximity of a plate cylinder and enables the plate surface to be cleaned by chemical and/or physical treatment and the images to be removed therefrom after the printing has been done via general printing steps, thereby effecting regeneration of the water-receptive support.

In the printing method and printing machine of the present invention, the image-forming layer is constituted mainly of uniform fine particles of a high molecular polymer. As these fine particles are attached to a support by electrodeposition, they are present in a semi-bonded state that there are voids among some particles although some particles are in contact with one another, in contrast to the case where they are coated. Therefore, in the image formation by heat fusion of fine particles upon scanning exposure to laser beams in the infrared region, the fine particles of a high molecular polymer have satisfactory heat-fusible properties and can ensure high image strength. In the unexposed areas (non-image areas), on the other hand, the fine particles are removed in aggregates of moderate sizes. So the fine particles in the unexposed areas can have good removability, or good developability, and can be removed using a fountain solution or ink on a printing machine . Thus, it becomes possible to make a lithographic printing plate generating no scumming and having a long press life.

According to the printing method and printing machine of the present invention, both formation of an image-forming layer by electrodeposition and imagewise exposure are performed on the printing machine. Accordingly, the present invention can embody the so-called Computer-to-Cylinder (CTC) printing system capable of eliminating a plate-making step. Thus, much time and cost required for usual PS plate production become unnecessary, so printings are obtainable at low prices and on short lead times. Moreover, the plate replacement after conclusion of each printing work becomes unnecessary, so that there is no need to dispose of waste plates, and savings in time, labor and cost become possible.

### EXAMPLE III-1

(Preparation of Aluminum Substrate)

An aluminum support was prepared in the same manner as in Example I-1.

The support prepared was immersed in a 2.5 weight % aqueous solution (pH: 11.2) of disodium trisilicate (No. 3) (SiO₂: 28 to 30 weight %, Na₂O: 9 to 10 weight %, Fe: 0.02 weight % or less) for 13 seconds at 70° C., and then washed with water. The silicate coverage on the support was 10 mg/m², determined by fluorescent X-ray analysis.

Further, a photocatalytic titanium dioxide water-receptive layer was formed on the thus processed support in the following manner.

[Composition of Photocatalytic Titanium Dioxide Dispersion]

Photocatalytic titanium dioxide sol (30% soln.) 167 g (Titanium Dioxide Slurry STS-02, produced by ISHIHARA SANGYO KAISHA LTD.)

| | |
|---|---|
| Tetramethoxysilane | 25 g |
| Trimethoxysilane | 25 g |
| Distilled water | 830 g |
| Ethanol | 700 g |

The above dispersion was coated on the support by means of a wire bar, and dried at 110° C. for 20 minutes to form a water-receptive layer at a coverage of 2 g/m2. Further, the water-receptive layer was exposed to light for 10 minutes by means of a 400 W high-pressure mercury lamp (UVL-400P, made by Rikokagaku Sangyo K.K.) placed at a distance of 10 cm from the layer. Thus, an aluminum substrate was prepared.

(Preparation of Particulate High Molecular Polymer Dispersion)

A particulate high molecular polymer dispersion was prepared in the same manner as in Example I-1.

The aluminum substrate having the foregoing photocyatalytic titanium dioxide water-receptive layer was immersed in the particulate high molecular polymer dispersion prepared in the foregoing manner, and a negative counter electrode was placed in the dispersion at a distance of 1 cm from the aluminum substrate used as a positive electrode. And a direct voltage of 2,000 V was applied between the positive electrode and the negative electrode to form 1.0 g/m² of electro-deposit of the particulate high molecular polymer on the substrate. The thus prepared printing plate precursor was exposed to semiconductor laser emitting infrared radiation of wavelength of 830 nm, and then subjected to usual printing operations without undergoing development. Therein, the printing was done with a printing machine (RYOBI 320OCCD). As a result, unexposed areas were completely removed at the initial stage of printing by which 50 sheets of printed matter, and thereafter scumming-free printing was achieved. The thus made printing plate enabled production of 10,000 sheets of good-quality printed matter.

At the conclusion of printing operations, the plate surface was wiped with waste impregnated with Ultra Plate Cleaner (produced by A.B.C. Chemical Co., Ltd.) to remove the ink and image areas left thereon, and further exposed to light for 10 minutes by means of a 400Whigh-pressure mercury lamp (UVL-400P, made by Rikokagaku Sangyo K.K.) placed at a distance of 10 cm from the plate surface, thereby regenerating the water-receptive substrate. Then, the particulate high molecular polymer was electrodeposited on the regenerated water-receptive substrate, and the printing plate precursor thus obtained was subjected to laser exposure and subsequently to printing operations again. As a result, good-quality printed sheets having sufficient densities in the image areas and no stains in the non-image areas were obtained.

### COMPARATIVE EXAMPLE III-1

Electrodeposition of the particulate high molecular polymer, laser exposure and printing were carried out in the same manners as in Example III-1, except that the photocatalytic titanium dioxide layer as a water-receptive layer was not provided on the aluminum support. In the first printing process, printed sheets obtained had sufficient density in their image areas and no stains in their non-image areas. After cleaning the printing plate in the same manner as in Example III-1, the particulate high molecular polymer was electrodeposited again, and laser exposure and printing operations were performed in the same manners as in Example III-1. However, the printed matters obtained were remarkable for stains in their non-image areas.

### EXAMPLE III-2

The aluminum substrate having the photocatalytic titanium dioxide layer prepared in Example III-1 was mounted on the plate cylinder of an offset printing machine made by Tokyo Koku Keiki K.K. Further, as shown in FIG. 2, an electrodeposition unit was placed at a distance of 5 mm from the aluminum substrate. The aluminum substrate was used as a positive electrode, and a direct voltage of 2,000 V was applied between the positive electrode and the electrodeposition unit.

Specifically, the particulate high molecular polymer dispersion prepared in Example III-1 was placed in an electrodeposition tank, and fed to a gap between the electrodeposition unit and the aluminum substrate by means of a pump. The aluminum substrate was set as a positive electrode and the electrodeposition unit was set as a negative electrode. And a direct voltage of 2,000 V was applied between the positive electrode and the negative electrode, thereby forming on the support a 0.6 g/m² of electro-deposit of the particulate high molecular polymer. The electro-deposit was exposed to semiconductor laser emitting 830 nm infrared radiation. Without development after exposure, the printing was done by using a fountain solution (IF201 produced by Fuji Photo Film Co., Ltd.) and printing ink (GEOS ink produced by Dai-Nippon Ink & Chemicals Inc.). The thus made printing plate attained scumming-free printing on the 30th-printed sheet after the beginning of printing operations, and enabled production of 10,000 sheets of good-quality printed matter.

### EXAMPLE III-2

In accordance with the placement as shown in FIG. 1, a plate surface-cleaning unit 5 having waste impregnated with Ultra Plate Cleaner (produced by A.B.C. Chemical Co., Ltd.) was disposed. By the use of this unit, the ink and the image areas left on the plate surface after the printing operations in Example III-1 were removed and dried. Further, ultraviolet irradiation was carried out using an ultraviolet irradiation device 8 to regenerate the water-receptive substrate. Then, the particulate high molecular polymer was electrodeposited again on the regenerated water-receptive substrate, and the printing plate precursor thus obtained was subjected to laser exposure and subsequently to printing operations in the same manners as in Example III-2. As a result, good-quality printed sheets having sufficient densities in the image areas and no stains in the non-image areas were obtained.

As described above, the lithographic printing plate precursor of the present invention has a water-receptive layer containing anatase-type particulate titanium dioxide and a resin having siloxane linkages, and enables formation of heat-fused images of electrodeposited fine particles and removal of non-image areas on the printing machine; as a result, printing can be done without development. Further, the printing plate precursor of the present invention can be made a printing plate capable of providing a great many printed sheets having clear images and no stains in the non-image areas.

By utilizing the resin having siloxane linkages as a resin for dispersing anatase-type titanium dioxide and forming a film by the use of a sol-gel method in particular, the present invention can have advantages that the water-receptive layer formed has high film strength and titanium dioxide particles are in a state of highly homogeneous dispersion.

When the lithographic printing plate precursor of the present invention is used, the non-image areas of the lithographic printing plate having undergone printing operations can be regenerated and have its original water-receptive state by removal of printing ink and ultraviolet irradiation. As a result, clearly printed sheets having no stains can be obtained even when the printing plate is used repeatedly.

By performing both formation of an image-forming layer by electrodeposition and imagewise exposure on a printing machine, the lithographic printing plate precursor, printing method and printing machine of the present invention can embody the so-called Computer-to-Cylinder (CTC) printing system capable of eliminating a plate-making step. Thus, much time and cost required for usual PS plate production become unnecessary, so printings are obtainable at low prices and on short lead times. Moreover, the plate replacement after conclusion of each printing work becomes unnecessary, so that there is no need to dispose of waste plates, and savings in time, labor and cost become possible.

### EXAMPLE IV-1

(Preparation of Dispersion of Fine Particles Having Whisker-shaped Projection Structure)

The ingredients constituting the following composition were placed in a TK Ross double planetary mixer, Model 13OLPM (made by Tokushu Kika K.K.), and kneaded at 95° C. for 1 hout while agitating at the revolutions of 50 r.p.m.

| | |
|---|---|
| Nucrel N-699 (produced by Mitsui Du-Pont | 3 pts. wt. |
| Chemical) | |
| Carbon black #40 (produced by MITSUBISHI | 1 pts. wt. |
| CHEMICAL CORPORATION) | |
| Isopar L (produced by Exxon) | 3 pts. wt. |

Further, the kneading was continued for additional 2 hours under the foregoing condition while adding 9 pts.wt. of Isopar L intermittently. The thus obtained matter was poured into a stainless vat, and cooled to room temperature to form a spongy kneaded matter. This kneaded matter was placed in a paint shaker wherein glass beads having diameters of about 4 mm were contained as media (made by Toyo Seiki K. K.), and dispersed preliminarily for 20 minutes.

Kneaded matter 1 pts.wt.

Isopar H 6 pts.wt.

This preliminary dispersion was further dispersed in a wet condition for 6 hours at revolutions of 4,500 r.p.m. by means of a KDL-type Dyno-Mill (made by Shinmaru Enterprises Co., Ltd.), thereby preparing a thick dispersion. In this dispersion step, fine particles having a whisker-shaped projecting structure were formed. Further, this dispersion was diluted with Isopar G so to have a solids concentration of 1 g/l, and thereto basic barium petronate (made by Witco Chemical Co., Ltd.) was added as an electric charge modifier in an amount of 0.1 g on a solids basis.

(Preparation of Aluminum Support)

An aluminum support was prepared in the same manner as in Example I-1.

The support prepared was immersed in a 2.5 weight % aqueous solution (pH: 11.2) of disodium trisilicate (No. 3) (SiO₂: 28 to 30 weight %, Na₂O: 9 to 10 weight %, Fe: 0.02 weight % or less) for 13 seconds at 70° C., and then washed with water. The silicate coverage on the support was 10 mg/m², determined by fluorescent X-ray analysis.

The aluminum support prepared above was immersed in the dispersion of particulate thermoplastic polymer having whisker-shaped projections, and a negative counter electrode was placed in the dispersion at a distance of 1 cm from the aluminum support used as a positive electrode. And a direct voltage of 2,000 V was applied between the positive electrode and the negative electrode. Therein, 0.6 g/m² of electro-deposit of the particulate thermoplastic polymer was formed on the support, and air-dried. The thus prepared printing plate precursor was exposed to semiconductor laser emitting infrared radiation of wavelength of 830 nm.

The thus image-drawn lithographic printing plate precursor was mounted on the cylinder of a printing machine (RYOBI 3200 CCD) without undergoing development, and subjected to printing operations using a fountain solution (IF201 produced by Fuji Photo Film Co., Ltd.) and printing ink (GEOS ink produced by Dai-Nippon Ink & Chemicals Inc.). The thus made printing plate attained scumming-free printing on the 30th-printed sheet after the beginning of printing operations, and enabled production of 10,000 sheets of good-quality printed matter.

### EXAMPLE IV-2

The same water-receptive aluminum support as prepared in Example IV-1 was mounted on the plate cylinder of an offset printing machine made by Tokyo Koku Keiki K.K. Further, as shown in FIG. 2, an electrodeposition unit was placed at a distance of 5 mm from the aluminum support. The aluminum support was used as a positive electrode, and a direct voltage of 2,000 V was applied between the positive electrode and the electrodeposition unit.

Specifically, the same dispersion of particulate thermoplastic polymer having whisker-shaped projections as prepared in Example IV-1 was placed in an electrodeposition tank, and fed to a gap between the electrodeposition unit and the aluminum support by means of a pump. The aluminum support was set as a positive electrode and the electrodeposition unit was set as a negative electrode. And a direct voltage of 2,000 V was applied between the positive electrode and the negative electrode, thereby forming on the support a 0.6 g/m² of electrolytic deposit of the particulate thermoplastic polymer. The electrolytic deposit was exposed to semiconductor laser emitting 830 nm infrared radiation. Without development after exposure, the printing was done by using a fountain solution (IF201 produced by Fuji Photo Film Co., Ltd.) and printing ink (GEOS ink produced by Dai-Nippon Ink & Chemicals Inc.). The thus made printing plate attained scumming-free printing on the 25th-printed matter after the beginning of printing operations, and enabled production of 10,000 sheets of good-quality printed matter.

### EXAMPLE IV-3

In accordance with the placement as shown in FIG. 1, a plate surface-cleaning unit 5 having waste impregnated with Ultra Plate Cleaner (produced by A.B.C. Chemical Co., Ltd.) was disposed. By the use of this unit, the ink and the image areas left on the plate surface after the printing operations in Example IV-2 were removed and dried to regenerate the water-receptive support. Then, the particulate thermoplastic polymer was electrodeposited again on the regenerated water-receptive support, and the printing plate precursor thus obtained was subjected to laser exposure and subsequently to printing operations in the same manners as in Example IV-2. As a result, good-quality printed sheets having sufficient densities in the image areas and no stains in the non-image areas were obtained.

As described above, the particulate thermoplastic polymer contained in the image-forming layer of the lithographic printing plate precursor of the present invention has multiple whisker-shaped projections, so thermoplastic polymer particles are in a state of tangled masses; as a result, in the image formation by heat fusion of fine particles through scanning exposure to laser beams in the infrared region, the high molecular polymer particles can have excellent heat fusibility (sensitivity) and ensure high image strength. In addition, the fine particles in non-image areas are removed in moderate-size masses, so that the removability (developability) is good, the non-image areas can be removed with a fountain solution or ink on a printing machine, and the lithographic printing plate generating no scumming and having a long press life can be made.

Further, the particulate layer (image-forming layer) to constitute the lithographic printing plate precursor of the present invention is formed on a support by applying an electric field between the support and a dispersion of charged particulate high molecular polymer having multiple whisker-shaped projections to cause electrodeposition of the particulate high molecular polymer on the support; as a result, fine particles are present in a semi-bonded state, in contrast to the case where they are coated. Accordingly, the sensitivity defined above, on-machine developability and impression capacity can be more remarkably improved.

Furthermore, the printing method of the present invention enables regeneration of a water-receptive support by installing a plate surface-cleaning unit in close proximity to a plate cylinder and cleaning the plate surface with chemical and/or physical treatment after conclusion of a printing work including usual printing operations to remove the images from the plate surface.

The lithographic printing plate precursor and the printing method of the present invention enable both formation of an image-forming layer by electrodeposition and imagewise exposure to be performed on a printing machine, and so they can embody a Computer-to-Cylinder (CTC) printing system capable of eliminating a plate-making step. Thus, much time and cost required for usual PS plate production become unnecessary, so printings are obtainable at low prices and on short lead times. Moreover, the plate replacement after conclusion of each printing work becomes unnecessary, so that there is no need to dispose of waste plates, and savings in time, labor and cost become possible.

While the invention has been described in detail and with reference to specific embodiments thereof, it will be apparent to one skilled in the art that various changes and modifications can be made therein without departing from the spirit and scope thereof.

What is claimed is:

1. A lithographic printing plate precursor comprising a support and an image-forming layer containing a particulate high molecular polymer, said image-forming layer being provided on the support by applying an electric field between the support and a dispersion containing an electric charged particulate high molecular polymer to cause electrodeposition of the particulate high molecular polymer on the support.

2. The lithographic printing plate precursor as in claim 1, wherein the particulate high molecular polymer has heat-fusible properties.

3. The lithographic printing plate precursor as in claim 1, wherein the dispersion is a disperse system containing the electric charged particulate high molecular polymer in an electric insulating liquid as a dispersion medium.

4. The lithographic printing plate precursor as in claim 1, wherein the dispersion further contains a light-to-heat converting agent.

5. A printing method comprising a step of forming a particulate layer on a water-receptive support mounted on a printing machine's plate cylinder by applying an electric field between the support and an electric charged particulate high molecular polymer to cause electrodeposition of the particulate high molecular polymer on the support, a step of subjecting the particulate layer to imagewise exposure, a step of removing non-image areas by applying ink or water thereto or by giving them a rub to make a printing plate, and a step of subjecting the printing plate to a printing work.

6. The printing method as in claim 5, further comprising a step of regenerating the water-receptive support after carrying out the printing work, wherein the printing plate surface is cleaned with chemical or physical treatment and thereby the image areas on the plate surface are removed.

7. A printing machine comprising a plate cylinder on which a water-receptive support is mounted, a device for forming a particulate layer on the water-receptive support by applying an electric field between the support and an electric charged particulate high molecular polymer to cause electrodeposition of the particulate high molecular polymer on the support, and an image drawing unit equipped with an exposure light source.

8. A lithographic printing plate precursor comprising a water-receptive support having a water-receptive layer containing anatase-type particulate titanium dioxide, and an image-forming layer provided on the support by applying an electric field between the support and a dispersion containing an electric charged particulate high molecular polymer to cause electrodeposition of the particulate high molecular polymer on the support.

9. A printing method comprising a step of forming an image-forming layer by applying an electric field between a water-receptive support provided with a water-receptive layer containing anatase-type particulate titanium dioxide and mounted on a printing machine's plate cylinder and a dispersion containing an electric charged particulate high molecular polymer in an electric insulating liquid to electrodeposit the particulate high molecular polymer on the support, a step of subjecting the image-forming layer to imagewise exposure, a step of removing non-image areas by applying ink or water thereto or giving them a rub to make a printing plate, and a step of carrying out a printing work after removal of the non-image areas.

10. The printing method as in claim 9, further comprising a step of regenerating the water-receptive support after carrying out the printing work, wherein the printing plate surface is cleaned with chemical or physical treatment to remove image areas therefrom and then irradiated with ultraviolet rays.

11. A printing machine comprising a plate cylinder on which a water-receptive support having a water-receptive layer containing anatase-type particulate titanium dioxide is mounted, a device for forming a particulate layer on the water-receptive support by applying an electric field between the support and an electric charged particulate high molecular polymer to cause electrodeposition of the particulate high molecular polymer on the support, an image drawing unit equipped with an exposure light source, a plate surface-cleaning unit and an ultraviolet irradiation device.

12. A lithographic printing plate precursor having on a support an image-forming layer comprising thermoplastic polymer particles having multiple whisker-shaped projections and a light-to-heat converting agent.

13. The lithographic printing plate precursor as in claim 12, wherein the image-forming layer is provided on the support by applying an electric field between the support and a dispersion containing at least thermoplastic polymer particles having multiple whisker-shaped projections, a light-to-heat converting agent and an electric charge modifier in an electric insulating liquid to cause electrodeposition of the thermoplastic polymer particles on the support.

14. A printing method comprising a step of forming an image-forming layer by applying an electric field between a water-receptive support mounted on a printing machine's plate cylinder and a dispersion containing at least thermoplastic polymer particles having multiple whisker-shaped projections, a light-to-heat converting agent and an electric charge modifier in an electric insulating liquid to cause electrodeposition of the thermoplastic polymer particles on the support, a step of subjecting the image-forming layer to imagewise exposure, and a step of carrying out printing after removal of non-image areas by applying ink or water or giving a rub.
